(19) United States
(12) Patent Application Publication
(10) Pub. No.: US 2020/0288158 A1
(43) Pub. Date: Sep. 10, 2020

(54) PREDICTION-DOMAIN FILTERING FOR VIDEO CODING

(71) Applicant: QUALCOMM Incorporated, San Diego, CA (US)

(72) Inventors: Dmytro Rusanovskyy, San Diego, CA (US); Kevin Pascal Andre Reuze, Voisins le bretonneux (FR); Vadim Seregin, San Diego, CA (US); Marta Karczewicz, San Diego, CA (US); Nan Hu, San Diego, CA (US)

(21) Appl. No.: 16/809,206

(22) Filed: Mar. 4, 2020

Related U.S. Application Data
(60) Provisional application No. 62/814,262, filed on Mar. 5, 2019.
(60) Provisional application No. 62/816,784, filed on Mar. 11, 2019.
(60) Provisional application No. 62/827,623, filed on Apr. 1, 2019.

(51) Int. Cl. H04N 19/44; H04N 19/70; H04N 19/50

(52) U.S. Cl. CPC H04N 19/44; H04N 19/50; H04N 19/70

(57) ABSTRACT

A method of decoding video data includes generating, by a video decoder implemented in circuitry, prediction information for a current block and determining, by the video decoder, a filter index value based on a syntax element signaled for the video data. The method further includes determining, by the video decoder, based on one or more of a height of the current block or a width of the current block and based on the filter index value, a filter type and filtering, by the video decoder, the prediction information using a filter corresponding to the filter type to generate filtered prediction information.

This application claims the benefit of U.S. Provisional Application No. 62/814,262, filed Mar. 5, 2019, U.S. Provisional Application No. 62/816,784, filed Mar. 11, 2019, and U.S. Provisional Application No. 62/827,623, filed Apr. 1, 2019, each of which is hereby incorporated by reference in its entirety.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for improving performance and reducing complexity of inter prediction by harmonization and combination of stages of diffusion, bilateral or transform domain filtering with interpolation filtering utilized in motion compensated prediction of video coder. Techniques described herein may use a block dependent signaling mechanism. For example, a filter index value of a particular value (e.g., ‘1’) may represent a first filter type when a current block has a first block size (e.g., block sizes having more than 64 samples). In this example, the filter index value of the particular value (e.g., ‘1’) may represent a second filter type when the current block has second block size (e.g., block sizes having less than 64 samples). In this way, a video encoder may “binarize” the filter type differently depending on a block size parameter (e.g., ratio of height to width, block size, etc.). Configuring a video encoder for block dependent signaling may reduce an amount of information signaled in a bitstream compared to video encoders that do not use block dependent signaling.

In one example, a method of decoding video data includes: generating, by a video decoder implemented in circuitry, prediction information for a current block; determining, by the video decoder, a filter index value based on a syntax element signaled for the video data; determining, by the video decoder, based on one or more of a height of the current block or a width of the current block and based on the filter index value, a filter type; and filtering, by the video decoder, the prediction information using a filter corresponding to the filter type to generate filtered prediction information.

In another example, a method of encoding video data includes: generating, by a video encoder implemented in circuitry, prediction information for a current block; filtering, by the video encoder, the prediction information using a filter corresponding to a filter type to generate filtered prediction information; determining, by the video encoder, based on one or more of a height of the current block or a width of the current block and based on the filter type, a filter index value; and encoding, by the video encoder, a syntax element based on the filter index value.

In one example, a device for decoding video data includes a memory configured to store video data and one or more processors implemented in circuitry and configured to: generate prediction information for a current block; determine a filter index value based on a syntax element signaled for the video data; determine, based on one or more of a height of the current block or a width of the current block and based on the filter index value, a filter type; and filter the prediction information using a filter corresponding to the filter type to generate filtered prediction information.

In another example, a device for encoding video data includes a memory configured to store video data and one or more processors implemented in circuitry and configured to: generate prediction information for a current block; filter the prediction information using a filter corresponding to a filter type to generate filtered prediction information; determine, based on one or more of a height of the current block or a width of the current block and based on the filter type, a filter index value; and encode a syntax element based on the filter index value.

In one example, a non-transitory computer-readable storage medium stores instructions that, when executed, cause one or more processors of a device configured to decode video data to: generate prediction information for a current block; determine a filter index value based on a syntax element signaled for the video data; determine, based on one or more of a height of the current block or a width of the current block and based on the filter index value, a filter type; and filter the prediction information using a filter corresponding to the filter type to generate filtered prediction information.

In another example, a non-transitory computer-readable storage medium stores instructions that, when executed, cause one or more processors of a device configured to encode video data to: generate prediction information for a current block; filter the prediction information using a filter corresponding to a filter type to generate filtered prediction information; determine, based on one or more of a height of the current block or a width of the current block and based on the filter type, a filter index value; and encode a syntax element based on the filter index value.

In one example, an apparatus configured to decode video data comprises: means for generating prediction information for a current block; means for determining a filter index value based on a syntax element signaled for the video data; means for determining, based on one or more of a height of the current block or a width of the current block and based on a filter index value, a filter type; and means for filtering the prediction information using a filter corresponding to the filter type to generate filtered prediction information.

In another example, an apparatus configured to encode video data comprises means for generating prediction information for a current block; means for filtering the prediction information using a filter corresponding to a filter type to generate filtered prediction information; means for determining, based on one or more of a height of the current block or a width of the current block and based on the filter type, a filter index value; and means for encoding a syntax element indicating the filter index value.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a conceptual diagram illustrating a block-based video encoder.

FIG. 5 is a conceptual diagram illustrating integer samples and fractional sample positions for quarter sample luma interpolation.

FIG. 6 is a conceptual diagram illustrating 4-parameter affine model.

FIG. 7 is a conceptual diagram illustrating 6-parameter affine model.

FIG. 8 is a conceptual diagram illustrating Affine Motion Vector (MV) field per sub-block.

FIG. 9 is a conceptual diagram illustrating Overlapped Block Motion Compensation (OBMC).

FIG. 10A is a conceptual diagram illustrating sub-blocks where OBMC applies for sub-blocks at a coding unit (CU)/prediction unit (PU) boundary.

FIG. 10B is a conceptual diagram illustrating sub-blocks where OBMC applies for sub-blocks in advanced motion vector prediction (AMVP) mode.

FIG. 11 is a conceptual diagram illustrating an inter prediction chain of a hybrid video codec with Uniform Directional Diffusion Filters (UDDF) following the motion compensation stage.

FIG. 12 is a conceptual diagram illustrating an inter prediction chain of a hybrid video codec with post reconstruction following the motion compensation stage.

FIG. 13 is a conceptual diagram illustrating neighboring samples utilized in bilateral filtering.

FIG. 14 is a conceptual diagram illustrating an inter prediction chain of the hybrid video codec with post reconstruction following the motion compensation stage.

FIG. 15 is a conceptual diagram illustrating an inter prediction chain of the hybrid video codec with post reconstruction following the motion compensation stage.

FIG. 16 is a conceptual diagram illustrating an example filtering process.

FIG. 17 is a conceptual diagram illustrating another example filtering process.

FIG. 18 is a conceptual drawing illustrating an example of intra slice reconstruction with an in-loop luma reshaper.

FIG. 19 is a conceptual drawing illustrating an example of inter slice reconstruction with an in-loop luma reshaper.

FIG. 20 is a conceptual drawing illustrating another example of inter slice reconstruction with an in-loop luma reshaper.

FIG. 21 is a conceptual drawing illustrating intra mode and inter mode reconstruction with an in-loop luma reshaper.

FIG. 22 is a conceptual drawing illustrating an inter prediction chain of the hybrid video codec with UDDF following the motion compensation stage.

FIG. 23 is a conceptual drawing illustrating neighboring samples of a current block and neighboring samples of a reference block.

FIG. 24 is a conceptual drawing illustrating Local Illumination Compensation (LIC) with bi-prediction.

FIG. 25 is a conceptual drawing illustrating LIC with multi hypothesis intra-inter coding.

FIG. 26 is a flowchart illustrating an example method for encoding a current block.

FIG. 27 is a flowchart illustrating an example method for decoding a current block of video data.

FIG. 28 is a flowchart illustrating an example method for encoding a current block using block dependent signaling.

FIG. 29 is a flowchart illustrating an example method for decoding a current block of video data using block dependent signaling.

### DETAILED DESCRIPTION

A video encoder may signal filter parameters (e.g., using a filter index) to a video decoder. The video decoder may apply a filter corresponding to the signaled filter parameters. In this way, the video encoder and the video decoder may apply consistent filter parameters to video data. For example, a video coder may signal a syntax element to indicate a first filter index value (e.g., a bin string of ‘0’) to represent a first filter type and signal the syntax element to indicate a second filter index value (e.g., a bin string of ‘10’) to represent a second filter type.

However, the video coder may be likely to select the first filter type for a first type of block (e.g., a small block, a wide block, a tall block, etc.) and may be likely to select the second filter type for a second type of block (e.g., a large block, a narrow block, a short block, etc.). As such, when signaling the first filter type, the video encoder may signal a relatively small bin string (e.g., ‘0’). In this example, however, the video encoder may signal a relatively large bin string (e.g., ‘10’, ‘110’, ‘111’, etc.) when signaling the second filter type, which may increase an amount of data used by the video encoder to signal video data to the video decoder compared to signaling the relatively small bin string.

In accordance with the techniques of the disclosure, a video encoder may be configured to determine, based on one or more of a height of the current block or a width of the current block and based on a filter type, a filter index value. For example, rather than using a relatively large bin string (e.g., ‘10’, ‘110’, ‘111’, etc.) when signaling the second filter type for the second type of block (e.g., a large block, a narrow block, a short block, etc.) that is frequently used for the second type of block, the video encoder may signal the second filter type using a relatively small bin string (e.g., ‘0’). The video coder may encode the syntax element based on the filter index value for output to a video decoder.

Similarly, a video decoder may be configured to determine a filter index value based on a syntax element signaled and determine, based on one or more of a height of the current block or a width of the current block and based on the filter index value, a filter type. For example, rather than selecting a first filter type when the filter index value indicates a relatively small bin string (e.g., ‘0’) regardless of block size parameters (e.g., a height of the block, a width of the block, etc.) of a block being decoded, the video decoder may select a filter type based on one or both of a height of the current block or a width of the current block. For example, the video decoder may interpret a filter index value of a particular value (e.g., ‘1’) as representing a first filter type when a current block has a first block size (e.g., block sizes having more than 64 samples). In this example, the video decoder may interpret the filter index value of the particular value (e.g., ‘1’) as representing a second filter type when the current block has second block size (e.g., block sizes having less than 64 samples). In this way, the video encoder may binarize the filter type differently depending on a block size parameter (e.g., ratio of height to width, block size, etc.). Configuring the video encoder and the video decoder for block dependent signaling may reduce an amount of information signaled in a bitstream compared to video encoders and video decoders that do not use block dependent signaling.

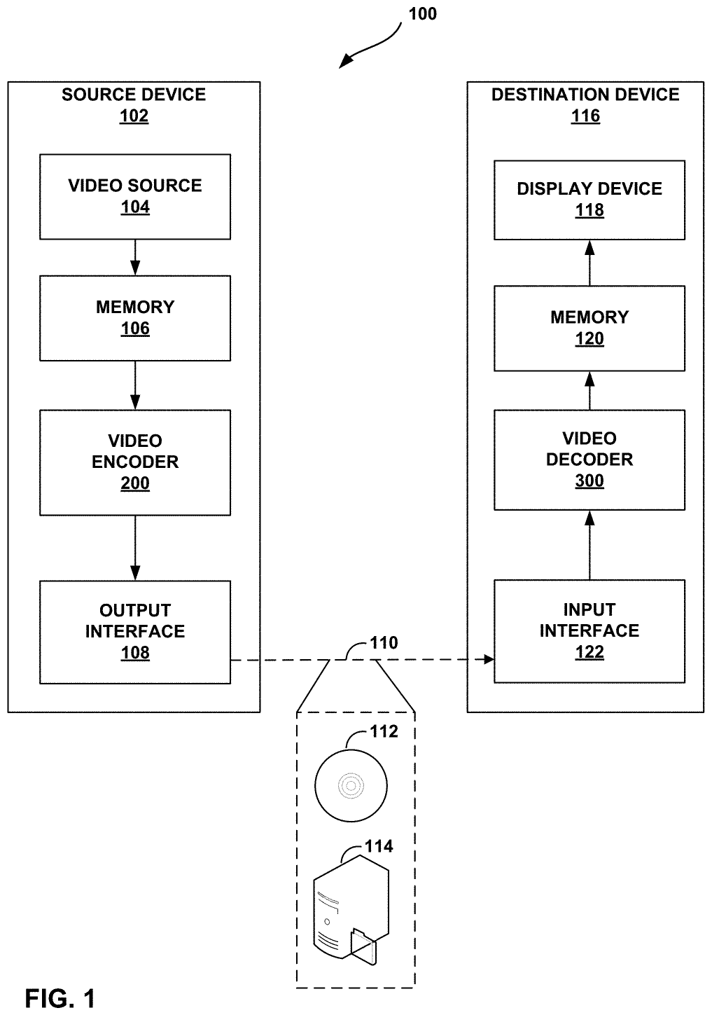

FIG. 1 is a block diagram illustrating an example video encoding and decoding system 100 that may perform the techniques of this disclosure. The techniques of this disclosure are generally directed to coding (e.g., encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may include any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply techniques for improving performance and reducing complexity of the inter prediction by harmonization and combination of stages of diffusion, bilateral or transform domain filter with interpolation filtering utilized in motion compensated prediction of video coder. For example, video encoder 200 may binarize the filter type differently depending on a block size parameter (e.g., ratio of height to width, block size, etc.). Configuring video encoder 200 and video decoder 300 for block dependent signaling may reduce an amount of information signaled in a bitstream compared to video encoders and video decoders that do not use block dependent signaling. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques for improving performance and reducing complexity of the inter prediction by harmonization and combining stages of diffusion, bilateral or transform domain filter with interpolation filtering utilized in motion compensated prediction of video coder. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally, or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the Joint Exploration Test Model (JEM) or ITU-T H.266, also referred to as Versatile Video Coding (VVC), presently under development. A draft of the VVC standard is described in Bross, et al. “Versatile Video Coding (Draft 8),” Joint Video Experts Team (JVET) of ITU-T SG 16 WP 3 and ISO/IEC JTC 1/SC 29/WG 11, 17^{th} Meeting: Brussels, BE, 7-17 Jan. 2020, JVET-Q2001-vA (hereinafter “VVC Draft 8”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to JEM or VVC. According to JEM or VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) partitions. A triple tree partition is a partition where a block is split into three sub-blocks. In some examples, a triple tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of JEM and VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of JEM and VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

To signal a filter type, a video encoder (e.g., video encoder 200) may represent each filter type by a bin string. For example, a first filter type (e.g., a filter suitable for local 2D filtering) may be assigned a bin string of 10, a second filter type (e.g., a first filter suitable for directional filtering) may be assigned a bin string of 110, and a third filter type (e.g., a second filter suitable for directional filtering) may be assigned a bin string of 111. While selecting filter types to maximize an accuracy of prediction blocks while minimizing an amount of information signaled, the video encoder may select filter types based on a block size parameter (e.g., a ratio of height and width, a number of samples, etc.).

In accordance with the techniques of the disclosure, rather than using a fixed table to assign filter types to bin strings, a video encoder may be configured to determine a filter index to be indicated by a syntax element based on a height of a current block and/or a width of the current block. For example, the video encoder may use a first signaling mechanism for a current block when the current block is not wide (e.g., width<N*height; N is an integer) and a second signaling mechanism for the current block when the current block is wide (e.g., width>N*height). In this way, the video encoder may binarize the filter type using fewer bits (e.g., more instances of “10” and fewer instances of “111”), which may reduce an amount of data signaled compared to systems that do not use block dependent signaling, e.g., conserving bandwidth. Reducing an amount of data signaled in a bitstream, may reduce an energy consumption of the video encoder and/or improve a processing speed of the video encoder. Similarly, a video decoder (e.g., video decoder 300 or in some examples, prediction processing unit 304 of video decoder 300) may decode less data signaled in a bitstream compared to systems that do not use block dependent signaling, which may reduce an energy consumption of the video decoder and/or improve a processing speed of the video decoder.

For example, video encoder 200 may be configured to generate prediction information for a current block and filter the prediction information using a filter corresponding to a filter type to generate filtered prediction information. In this example, video encoder 200 may be configured to determine, based on one or more of a height of the current block or a width of the current block and based on the filter type, a filter index value and encode a syntax element indicating the filter index value for the video data.

Video decoder 300 may be configured to generate prediction information for a current block and determine a filter index value based on a syntax element signaled for the video data. In this example, video decoder 300 may be configured to determine, based on one or more of a height of the current block or a width of the current block and based on the filter index value, a filter type and filter the prediction information using a filter corresponding to the filter type to generate filtered prediction information.

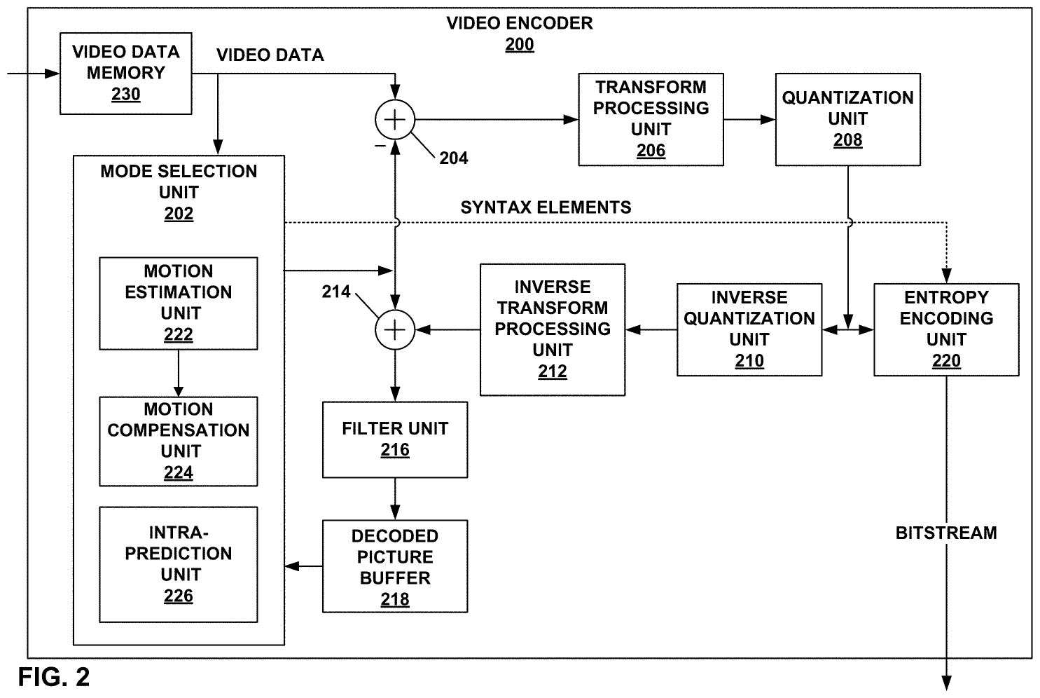

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 in the context of video coding standards such as the HEVC (H.265) video coding standard and the VVC (H.266) video coding standard in development. However, the techniques of this disclosure are not limited to these video coding standards, and are applicable generally to video encoding and decoding.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

Motion compensation unit 224 may filter prediction information using a filter corresponding to a filter type to generate filtered prediction information. In this example, mode selection unit 202 may determine, based on a height of the current block and/or a width of the current block and based on the filter type, a filter index value. Entropy encoding unit 220 may entropy encode a syntax element based on the filter index value in a bitstream for the video data.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as a few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

Video encoder 200 represents an example of a device configured to: encode video data including a memory configured to store video data, and one or more processing units implemented in circuitry configured to: generate prediction information for a current block and filter the prediction information using a filter corresponding to a filter type to generate filtered prediction information; determine, based on one or more of a height of the current block or a width of the current block and based on the filter type, a filter index value; and encode a syntax element based on the filter index value. In this way, video encoder 200 (e.g., mode selection unit 202) may binarize the filter type differently depending on a block size parameter (e.g., ratio of height to width, block size, etc.). Configuring video encoder 200 (e.g., mode selection unit 202) for block dependent signaling may reduce an amount of information signaled in a bitstream compared to video encoders that do not use block dependent signaling.

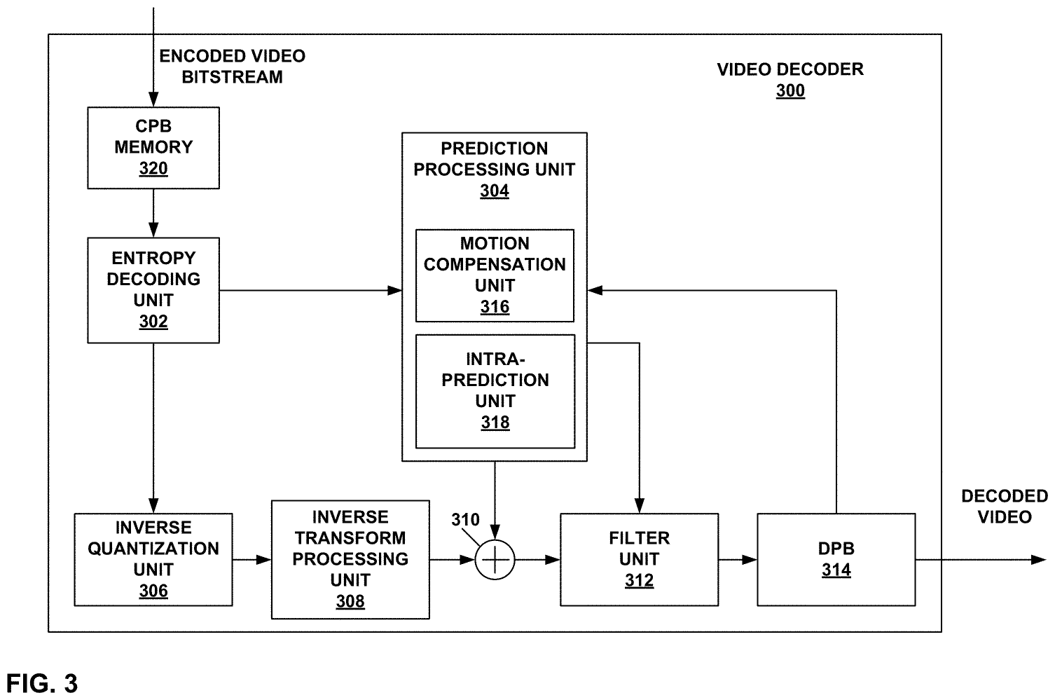

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 is described according to the techniques of JEM, VVC, and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. Moreover, video decoder 300 may include additional or alternative processors or processing circuitry to perform these and other functions.

Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally, or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

Entropy decoding unit 302 may determine (e.g., decode, entropy decode, etc.) a filter index value based on a syntax element signaled in a bitstream for video data. Prediction processing unit 304 may determine, based on a height of the current block and/or a width of the current block and based on the filter index value, a filter type. Motion compensation unit 316 may filter the prediction information using a filter corresponding to the filter type to generate filtered prediction information.

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

In this manner, video decoder 300 represents an example of a video decoding device including a memory configured to store video data, and one or more processing units implemented in circuitry and configured to: generate prediction information for a current block; determine a filter index value based on a syntax element for the video data; determine, based on one or more of a height of the current block or a width of the current block and based on the filter index value, a filter type; and filter the prediction information using a filter corresponding to the filter type to generate filtered prediction information. In this way, video decoder may inverse binarize the filter type differently depending on a block size parameter (e.g., ratio of height to width, block size, etc.). Configuring video decoder 300 (e.g., prediction processing unit 304) for block dependent signaling may reduce an amount of information signaled in a bitstream compared to video decoders that do not use block dependent signaling.

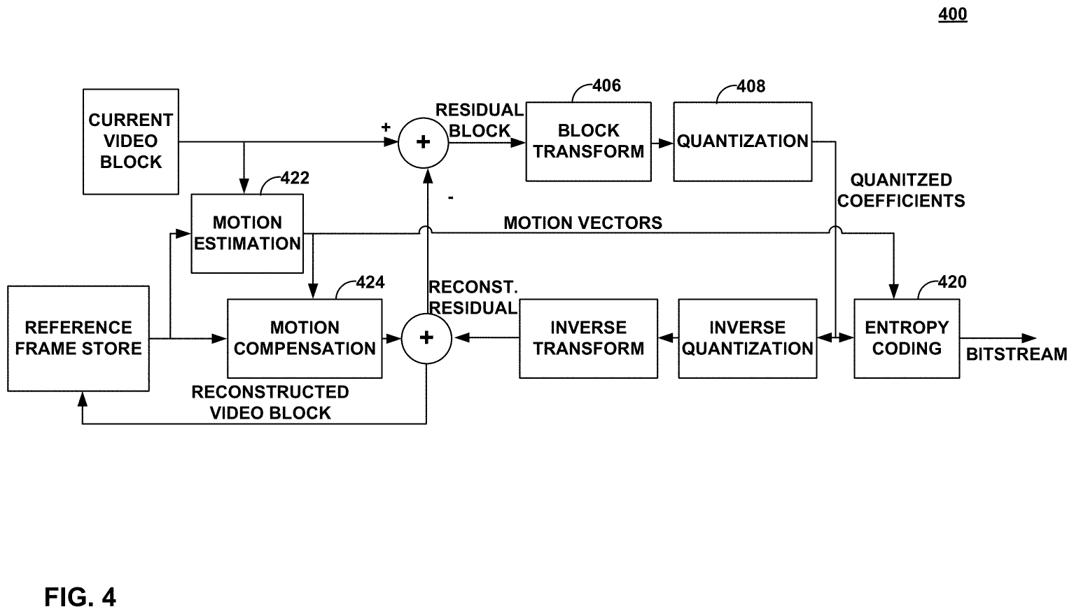

FIG. 4 is a conceptual diagram illustrating a block-based video encoder 400. A video encoder (e.g., video encoder 200 or in some examples, mode selection unit 202 of video encoder 200) may perform the steps illustrated in FIG. 4. Video compression technologies perform spatial and temporal prediction to reduce or remove the redundancy inherent in input video signals. In order to reduce temporal redundancy (that is, similarities between video signals in neighboring frames), motion estimation 422 is carried out to track the movement of video objects. Motion estimation 422 may be done on blocks of variable sizes. The object displacement as the outcome of motion estimation 422 is commonly known as motion vectors. Motion vectors may have half-, quarter-pixel, 1/16^{th}-pixel precisions (or any finer precisions); this allows the video coder to track motion field in higher precision than integer-pixel locations and hence obtain a better prediction block. When motion vectors with fractional pixel values are used, interpolation operations may be carried out.

After motion estimation 422, the best motion vector may be decided using a certain rate-distortion model. Then, the prediction video block is formed by motion compensation 424 using the best motion vector. The residual video block may be formed by subtracting the prediction video block from the original video block. A block transform 406 may then applied on the residual block. The transform coefficients are quantized 408 and entropy coded 420 to further reduce bit rate. Note that some video coding systems, such as the H.264/AVC or HEVC standard, also allow spatial prediction for intra coded blocks, which is not depicted in FIG. 4.

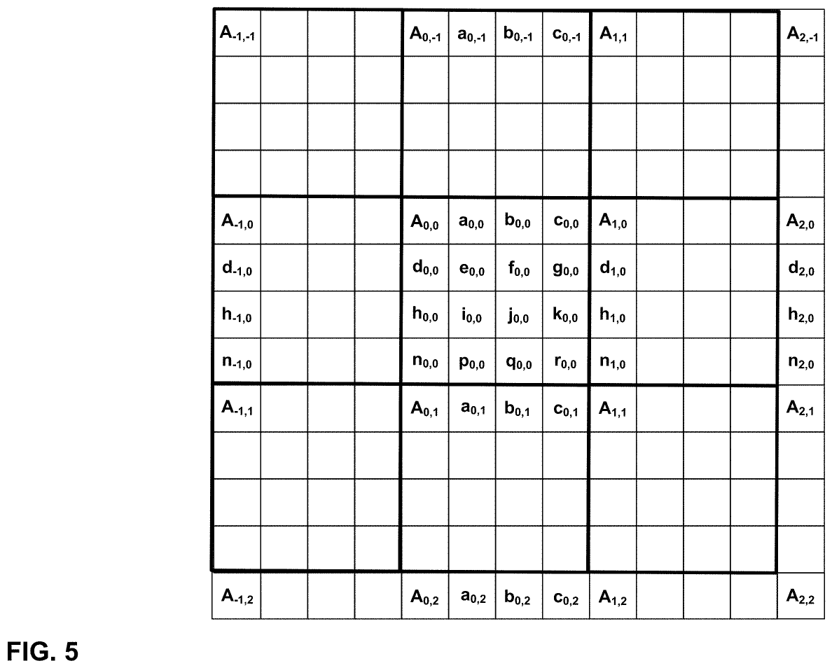

FIG. 5 is a conceptual diagram illustrating integer samples (blocks with upper-case letters) and fractional sample positions (blocks with lower-case letters) for quarter sample luma interpolation. Using ¼-pixel precision as an example, FIG. 5 shows the integer-pixel samples (also called full-pixel, shown in shaded blocks with upper-case letters) from the reference frame that are used to interpolate the fractional pixel (also called sub-pixel, shown in un-shaded blocks with lower-case letters) samples. There are altogether 15 sub-pixel positions, labeled “a_{0,0}” through “r_{0,0}” in FIG. 5. In HEVC, a video code (e.g., video encoder 200 or video decoder 300) derive the samples labelled a_{0,0}, b_{0,0}, c_{0,0}, d_{0,0}, h_{0,0}, and n_{0,0} by applying an 8-tap filter to the nearest integer position samples. The video coder derives the samples labelled e_{0,0}, i_{0,0}, p_{0,0}, f_{0,0}, j_{0,0}, q_{0,0}, g_{0,0}, k_{0,0}, and r_{0,0} by applying an 8-tap filter to the samples a_{0,i}, b_{0,i} and c_{0,i} with i=−3 . . . 4 in the vertical direction. The 8-tap filter to be applied is shown in Table 1.

TABLE 1
HEVC 8-tap luma interpolation filter for quarter-pel mv accuracy.

| Phase shift | Coefficients |
|---|---|
| 0 | {0, 0, 0, 64, 0, 0, 0, 0} |
| 1 | {−1, 4, −10, 58, 17, −5, 1, 0} |
| 2 | {−1, 4, −11, 40, 40, −11, 4, −1} |
| 3 | {0, 1, −5, 17, 58, −10, 4, −1} |

In JEM, 1/16^{th}-mv resolution is enabled; thus filters with 16 different phases may be used for interpolation, as shown in Table 2 below. However, a fixed set of 8-tap filters is being utilized for interpolation. For example, a vide coder (e.g., video encoder 200 or video decoder 300 or in some examples, mode selection unit 202 of video encoder 200, prediction processing unit 304 of video decoder 300) may apply an 8-tap filter with weights {0, 0, 0, 64, 0, 0, 0, 0} for a phase shift of 0, may apply an 8-tap filter with weights {−1, 4, −10, 58, 17, −5, 1, 0} for a phase shift of 1, and so on.

Techniques for block dependent signaling may be used for signaling a filter type used for filtering (e.g., the interpolation) in the example of FIG. 5. For example, a video encoder (e.g., video encoder 200 or in some examples, mode selection unit 202 of video encoder 200) may determine, based on a height of a current block and/or a width of the current block and based on a filter type, a filter index value for interpolation in FIG. 5. A video decoder (e.g., video decoder 300 or in some examples, prediction processing unit 304 of video decoder 300) may determine, based on a height of a current block and/or a width of the current block and based on a filter index value, a filter type for the interpolation in FIG. 5. For instance, the video coder may determine a filter type indicating a phase shift from Table 1 and/or Table 2 based on a height of a current block and/or a width of the current block. For example, the video coder may apply an 8-tap filter with weights {0, 0, 0, 64, 0, 0, 0, 0} in response to determining a filter type indicating a phase shift of 0, may apply an 8-tap filter with weights {0, 1, −3, 63, 4, −2, 1, 0} in response to determining a filter type indicating a phase shift of 1, and so on.

In this way, the video coder (e.g., e.g., video encoder 200 or video decoder 300 or in some examples, mode selection unit 202 of video encoder 200, prediction processing unit 304 of video decoder 300) may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

TABLE 2
8-tap luma interpolation filter for 1/16-pel mv accuracy in JEM

| Phase shift | Coefficients |
|---|---|
| 0 | {0, 0, 0, 64, 0, 0, 0, 0} |
| 1 | {0, 1, −3, 63, 4, −2, 1, 0} |
| 2 | {−1, 2, −5, 62, 8, −3, 1, 0} |
| 3 | {−1, 3, −8, 60, 13, −4, 1, 0} |
| 4 | {−1, 4, −10, 58, 17, −5, 1, 0} |
| 5 | {−1, 4, −11, 52, 26, −8, 3, −1} |
| 6 | {−1, 3, −9, 47, 31, −10, 4, −1} |
| 7 | {−1, 4, −11, 45, 34, −10, 4, −1} |
| 8 | {−1, 4, −11, 40, 40, −11, 4, −1} |
| 9 | {−1, 4, −10, 34, 45, −11, 4, −1} |
| 10 | {−1, 4, −10, 31, 47, −9, 3, −1} |
| 11 | {−1, 3, −8, 26, 52, −11, 4, −1} |
| 12 | {0, 1, −5, 17, 58, −10, 4, −1} |
| 13 | {0, 1, −4, 13, 60, −8, 3, −1} |
| 14 | {0, 1, −3, 8, 62, −5, 2, −1} |
| 15 | {0, 1, −2, 4, 63, −3, 1, 0} |

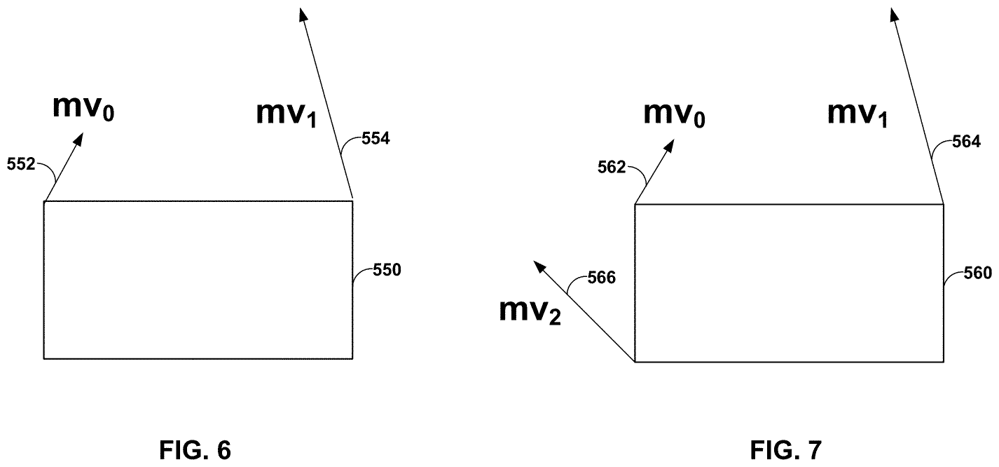

FIG. 6 is a conceptual diagram illustrating 4-parameter affine model. As shown, a first control point motion vector 552 (“mv₀”) is arranged on an upper-left corner of a block 550 and a second control point motion vector 554 (“mv₁”) is arranged on an upper-right corner of block 550.

Techniques for block dependent signaling may be used for signaling a filter type used for filtering (e.g., the affine motion compensation) in the example of FIG. 6. For example, a video encoder (e.g., video encoder 200 or in some examples, mode selection unit 202 of video encoder 200) may determine, based on a height of a current block and/or a width of the current block and based on a filter type, a filter index value for the affine motion compensation in FIG. 6. A video decoder (e.g., video decoder 300 or in some examples, prediction processing unit 304 of video decoder 300) may determine, based on a height of a current block and/or a width of the current block and based on a filter index value, a filter type for the affine motion compensation in FIG. 6.

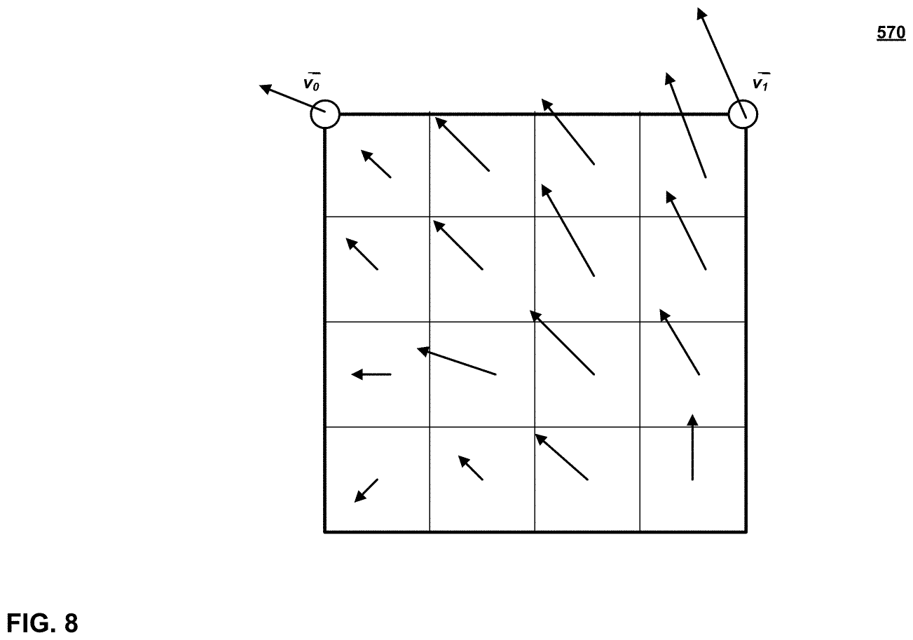

FIG. 7 is a conceptual diagram illustrating 6-parameter affine model. As shown, a first control point motion vector 562 (“mv₀”) is arranged on an upper-left corner of a block 560, a second control point motion vector 562 (“mv₁”) is arranged on an upper-right corner of block 560, and a third control point motion vector 564 (“mv₂”) is arranged on an lower-left corner of block 560.

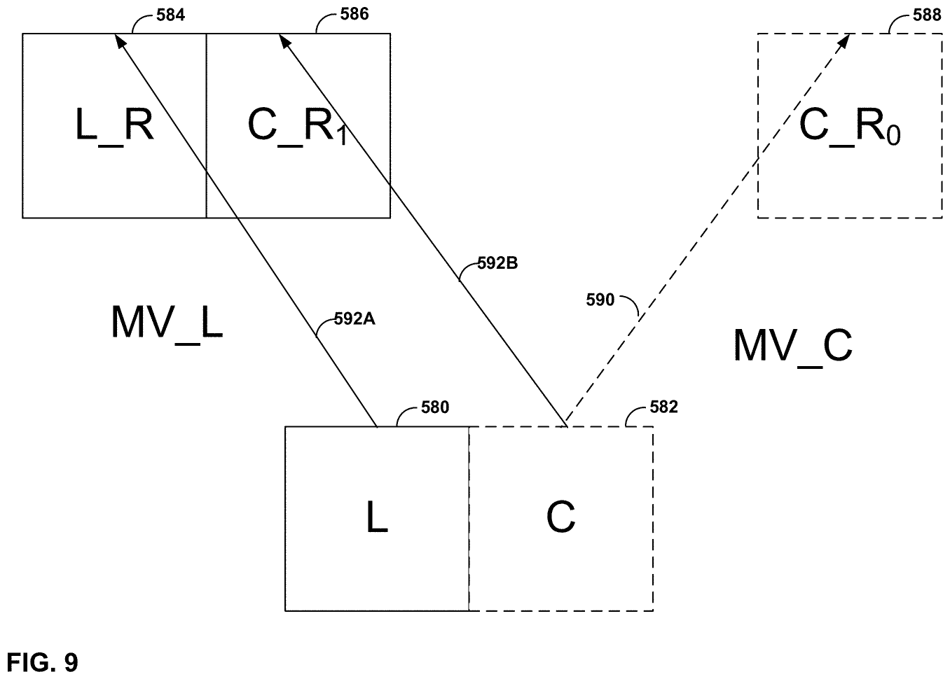

In HEVC, only translation motion model is applied for motion compensation prediction (MCP). In the real world, there are many kinds of motion, e.g. zoom in/out, rotation, perspective motions and the other irregular motions. In JEM, a simplified affine transform motion compensation prediction is applied. As shown FIGS. 7 and 8, the affine motion field of the block is described by two or three control point motion vectors (CPMV).

The motion vector field (MVF) of a block of 4-parameter affine model and 6-parameter affine model is described by the following two equations:

$$\begin{matrix}\{ \begin{matrix}m {v}_{x} = \frac{( m {v}_{1 x} - m {v}_{0 x} )}{w} x - \frac{( m {v}_{1 y} - m {v}_{0 y} )}{w} y + m {v}_{0 x} \\ m {v}_{y} = \frac{( m {v}_{1 y} - m {v}_{0 y} )}{w} x + \frac{( m {v}_{1 x} - m {v}_{0 x} )}{w} y + m {v}_{0 y}\end{matrix} & EQUATION 1 \\ \{ \begin{matrix}m {v}_{x} = \frac{( m {v}_{1 x} - m {v}_{0 x} )}{w} x - \frac{( m {v}_{2 x} - m {v}_{0 x} )}{h} y + m {v}_{0 x} \\ m {v}_{y} = \frac{( m {v}_{1 y} - m {v}_{0 y} )}{w} x + \frac{( m {v}_{2 y} - m {v}_{0 y} )}{h} y + m {v}_{0 y}\end{matrix} & EQUATION 2\end{matrix}$$

where (mv₀ₓ, mv_{0y}), (mv₁ₓ, mv_{1y}), (mv₂ₓ, mv_{2y}) are motion vectors of the top-left, top-right, and bottom-left corner control point.

Techniques for block dependent signaling may be used for signaling a filter type used for filtering (e.g., the affine motion compensation) in the example of FIG. 7. For example, a video encoder (e.g., video encoder 200 or in some examples, mode selection unit 202 of video encoder 200) may determine, based on a height of a current block and/or a width of the current block and based on a filter type, a filter index value for the affine motion compensation in FIG. 7. A video decoder (e.g., video decoder 300 or in some examples, prediction processing unit 304 of video decoder 300) may determine, based on a height of a current block and/or a width of the current block and based on a filter index value, a filter type for the affine motion compensation in FIG. 7.

FIG. 8 is a conceptual diagram illustrating Affine MV field per sub-block of block 570. In order to further simplify the motion compensation prediction, sub-block based affine transform prediction with block size 4×4 is applied. To derive motion vector of each 4×4 sub-block, a video coder (e.g., video encoder 200 or video decoder 300 or in some examples, mode selection unit 202 of video encoder 200, prediction processing unit 304 of video decoder 300) may calculate the motion vector of the center sample of each sub-block, as shown in FIG. 8, according to Equation 1 or Equation 2 and round a result to 1/16 fraction accuracy. After motion compensation prediction, the video coder may round the high accuracy motion vector of each sub-block and save the motion compensation prediction as the same accuracy as the normal motion vector.

Techniques for block dependent signaling may be used for signaling a filter type used for filtering (e.g., the affine motion compensation) in the example of FIG. 8. For example, a video encoder (e.g., video encoder 200 or in some examples, mode selection unit 202 of video encoder 200) may determine, based on a height of a current block and/or a width of the current block and based on a filter type, a filter index value for the affine motion compensation in FIG. 8. A video decoder (e.g., video decoder 300 or in some examples, prediction processing unit 304 of video decoder 300) may determine, based on a height of a current block and/or a width of the current block and based on a filter index value, a filter type for the affine motion compensation in FIG. 8.

Overlapped Block Motion Compensation (OBMC) may be used in H.263. In JEM, unlike in H.263, OBMC can be switched on and off using syntax at the CU level. When OBMC is used in the JEM, the OBMC is performed for all motion compensation (MC) block boundaries except the right and bottom boundaries of a CU. Moreover, OBMC is applied for both the luma and chroma components. OBMC is an example of filtering in the prediction domain. For example, filter type and/or filter parameters for OBMC may be signaled by video encoder 200 and decoded by video decoder 300.

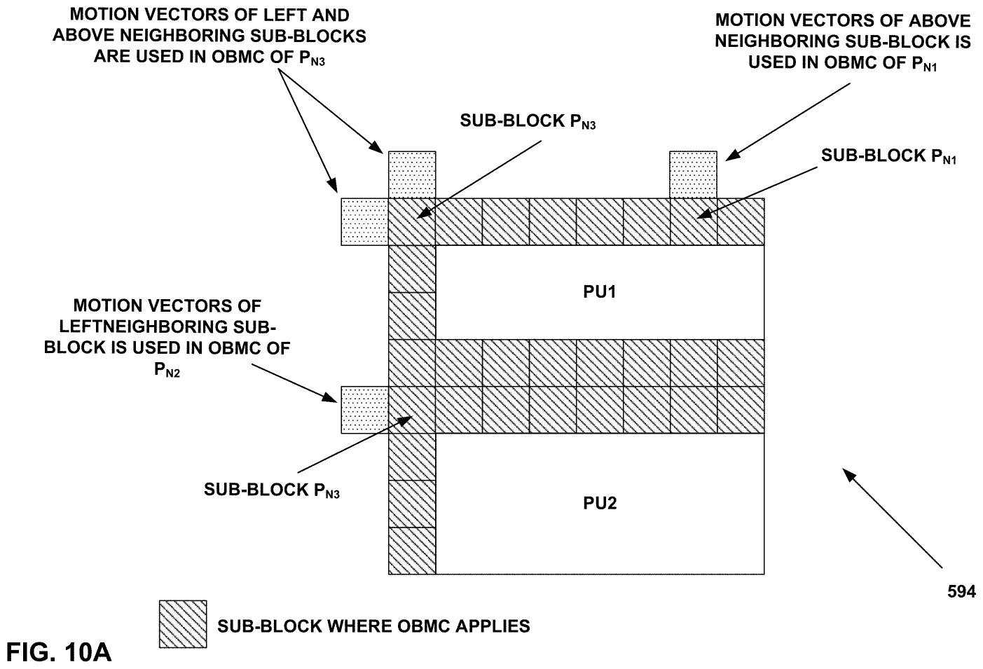

FIG. 9 is a conceptual diagram illustrating Overlapped Block Motion Compensation (OBMC). Current block 582 (“C”) has a MV 590 (“MV_C”) pointing to reference block 588 (“C_R₀”). Neighboring block 580 (“L”) is a left neighbor to current block 582. Neighboring block 580 also has a MV 592A (“MV_L”) pointing to a reference block 584 (“L_R) for neighboring block 580. Current block 582 can use MV 592B, which corresponds to MV 592A, to get another reference block 586 (“C_R₁”). A video coder (e.g., video encoder 200 or video decoder 300) may multiply reference block 588 and reference block 586 by weighting factors and add the results together to form a final prediction signal of current block 582. Reference block 586 may help to reduce boundary effect between neighboring block 580 and current block 582 due to being beside (e.g., adjacent to) reference block 584 for neighboring block 580.

Techniques for block dependent signaling may be used for signaling a filter type used for filtering (e.g., the OBMC) in the example of FIG. 9. For example, a video encoder (e.g., video encoder 200 or in some examples, mode selection unit 202 of video encoder 200) may determine, based on a height of a current block and/or a width of the current block and based on a filter type for OBMC, a filter index value for OBMC (e.g., weighting factors) in FIG. 9. A video decoder (e.g., video decoder 300 or in some examples, prediction processing unit 304 of video decoder 300) may determine, based on a height of a current block and/or a width of the current block and based on a filter index value for OBMC, a filter type for OBMC (e.g., weighting factors) in FIG. 9.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for OBMC) when a current block has a first block size (e.g., block sizes having more than 64 samples). In this example, the video decoder may interpret the filter index value of the particular value (e.g., ‘1’) as representing a second filter type (e.g., having a second weighting factor for OBMC) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

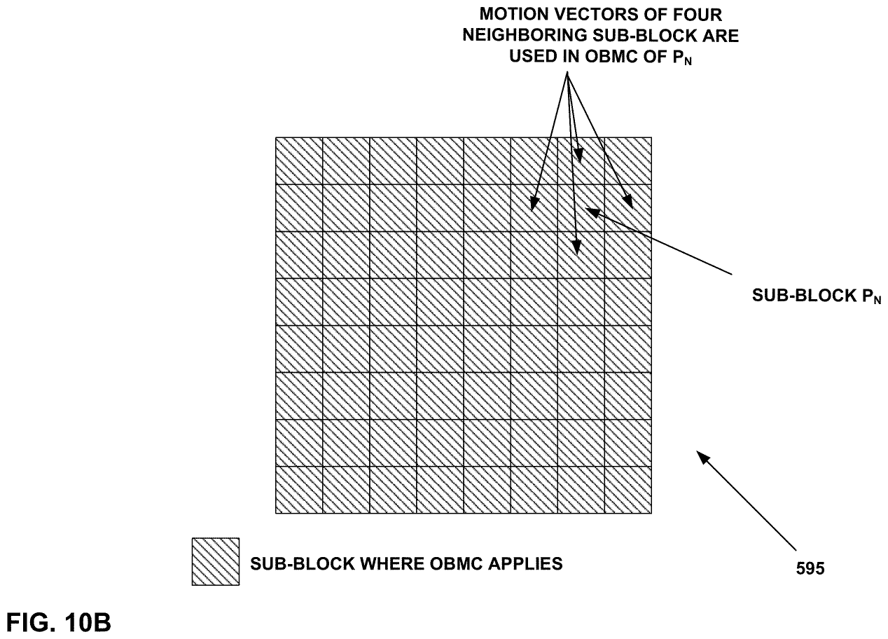

FIG. 10A is a conceptual diagram illustrating sub-blocks where OBMC applies for sub-blocks at a coding unit (CU) and/or prediction unit (PU) boundary. FIG. 10A is discussed with FIG. 10B. FIG. 10B is a conceptual diagram illustrating sub-blocks where OBMC applies for sub-blocks in AMVP mode.

In the JEM, a MC block corresponds to a coding block. When a CU is coded with sub-CU mode (includes sub-CU merge, affine and frame rate up-conversion (FRUC) mode), each sub-block of the CU is a MC block. To process CU boundaries in a uniform fashion, a video coder (e.g., video encoder 200 or video decoder 300) may perform OBMC at sub-block level for all MC block boundaries, where the sub-block size is set equal to 4×4, as illustrated in FIGS. 10A, 10B.

When OBMC applies to the current sub-block, besides current motion vectors, a video coder (e.g., video encoder 200 or video decoder 300) may use motion vectors of four connected neighbouring sub-blocks, if available and not identical to the current motion vector, to derive a prediction block for the current sub-block. The video coder may combine these multiple prediction blocks based on multiple motion vectors to generate the final prediction signal of the current sub-block.

A prediction block based on motion vectors of a neighbouring sub-block is denoted as P_{N}, with N indicating an index for the neighbouring above, below, left and right sub-blocks and a prediction block based on motion vectors of the current sub-block is denoted as P_{C}. When P_{N} is based on the motion information of a neighbouring sub-block that contains the same motion information to the current sub-block, a video coder (e.g., video encoder 200 or video decoder 300) may not perform the OBMC from P_{N}. Otherwise, the video coder may add every sample of P_{N} to the same sample in P_{C}, e.g., four rows/columns of P_{N} are added to P_{C}. The video coder may use the weighting factors {¼, ⅛, 1/16, 1/32} for P_{N} and may use the weighting factors {¾, ⅞, 15/16, 31/32} for P_{C}. The exceptions are small MC blocks, (e.g., when height or width of the coding block is equal to 4 or a CU is coded with sub-CU mode), for which the video coder may only add two rows/columns of P_{N} to P_{C}. In this case, the video coder may use weighting factors {¼, ⅛} for P_{N} and use weighting factors {¾, ⅞} for P_{C}. For P_{N} generated based on motion vectors of vertically (horizontally) neighbouring sub-block, the video coder may add samples in the same row (e.g., column) of P_{N} to P_{C} with a same weighting factor.

In the JEM, for a CU with size less than or equal to 256 luma samples, a video encoder (e.g., video encoder 200 or in some examples, mode selection unit 202 of video encoder 200) may signal a CU level flag to indicate whether OBMC is applied or not for the current CU. For the CUs with size larger than 256 luma samples or that are not coded with AMVP mode, a video coder (e.g., video encoder 200 or video decoder 300) may apply OBMC by default. At the video encoder (e.g., video encoder 200 or in some examples, mode selection unit 202 of video encoder 200), when OBMC is applied for a CU, the impact of OBMC is determined during the motion estimation stage. The video coder may use the prediction signal formed by OBMC using motion information of the top neighbouring block and the left neighbouring block to compensate the top and left boundaries of the original signal of the current CU, and then apply a motion estimation process.

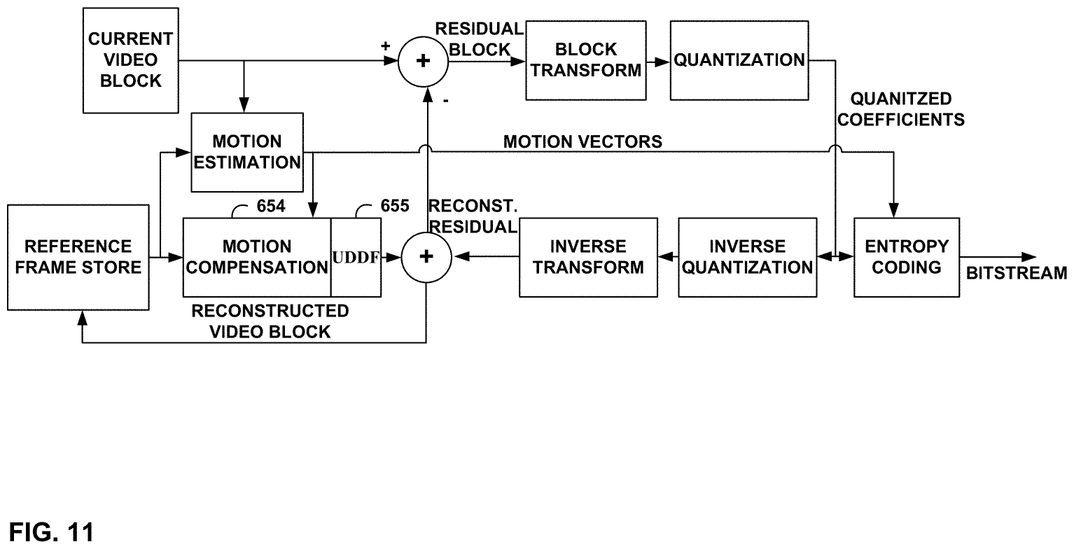

Techniques for block dependent signaling may be used for signaling a filter type used for filtering (e.g., the OBMC) in the example of FIGS. 10A, 10B. For example, a video encoder (e.g., video encoder 200 or in some examples, mode selection unit 202 of video encoder 200) may determine, based on a height of a current block (e.g., current block 594 of FIG. 11A or current block 595 of FIG. 11B) and/or a width of the current block and based on a filter type for OBMC (e.g., weighting factors), a filter index value for OBMC in FIGS. 10A, 10B. A video decoder (e.g., video decoder 300 or in some examples, prediction processing unit 304 of video decoder 300) may determine, based on a height of a current block (e.g., current block 594 of FIG. 11A or current block 595 of FIG. 11B) and/or a width of the current block and based on a filter index value, a filter type for OBMC (e.g., weighting factors) in FIGS. 10A, 10B.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for P_{N} to P_{C}) when a current block (e.g., current block 594 of FIG. 11A or current block 595 of FIG. 11B) has a first block size (e.g., block sizes having more than 64 samples). In this example, the video decoder may interpret the filter index value of the particular value (e.g., ‘1’) as representing a second filter type (e.g., having a second weighting factor for P_{N} to P_{C}) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

FIG. 11 is a conceptual diagram illustrating an inter prediction chain of the hybrid video codec with Uniform Directional Diffusion Filters (UDDF) following the motion compensation stage. An example version of the Uniform Directional Diffusion Filters (UDDF) was proposed and tested in Rasch, et al. “CE10: Uniform Directional Diffusion Filters For Video Coding,” Joint Video Experts Team (WET) of ITU-T SG 16 WP 3 and ISO/IEC JTC 1/SC 29/WG 11, 13th Meeting: Marrakech, MA, 9-18 Jan. 2019, WET-M004241 (hereinafter “JVET-M0042”). In the example of FIG. 11, motion compensation 654 includes UDDF 655. UDDF may be defined through two types of filters: 2D filter size of 3×3 and directional 1D filter size of 1×9. UDDF is an example of filtering in the prediction domain. For example, filter type and/or filter parameters for UDDF may be signaled by video encoder 200 and decoded by video decoder 300.

A video coder (e.g., video encoder 200 or video decoder 300) may determine pred to be the prediction signal on a given block obtained by intra or motion compensated prediction. In order to handle boundary points for the filters, the video coder may extend the prediction signal to a prediction signal predₑₓₜ. To form the extended prediction, the video coder may add one line of reconstructed samples left and above the block to the prediction signal and mirror the resulting signal in all directions. The UDDF may be realized by convolving the prediction signal with a fixed mask that is given as h^{l}, defined below. In some examples, the video coder may be configured to replace the prediction signal pred as follows using the boundary extension described above.

h^{l}*pred,

Here, the filter mask h^{l} is given as

$${h}^{l} = 0.125 ( \begin{matrix}0 & 1 & 0 \\ 1 & 4 & 1 \\ 0 & 1 & 0\end{matrix} ) \qquad EQUATION 3$$

The directional filters may be defined separately for a horizontal filter h^{hor} and a vertical filter h^{ver}, specified through a fixed mask. A video coder (e.g., video encoder 200 or video decoder 300) may be configured to restrict the filtering to be either applied only along the vertical or only along the horizontal direction. The video coder may be configured to realize the vertical filter by applying the fixed filter mask hᵥₑᵣ of Equation 4 to the prediction signal and realize the horizontal filter by using the transposed mask of Equation 5.

$$\begin{matrix}{h}_{ver} = {( 0.5 )}^{4} ( \begin{matrix}1 \\ 0 \\ 4 \\ 0 \\ 6 \\ 0 \\ 4 \\ 0 \\ 1\end{matrix} ) & EQUATION 4 \\ {h}_{hor} = {h}_{ver}^{t} . & EQUATION 5\end{matrix}$$

A video coder (e.g., video encoder 200 or video decoder 300) may be configured to perform the extension of the prediction signal similarly to the previous section.

Techniques for block dependent signaling may be used for signaling a filter type used for filtering (e.g., applying UDDF) in the example of FIG. 11. For example, a video encoder (e.g., video encoder 200 or in some examples, mode selection unit 202 of video encoder 200) may determine, based on a height of a current block and/or a width of the current block and based on a filter type for UDDF (e.g., a horizontal filter, a vertical filter, etc.), a filter index value for UDDF in FIG. 11. A video decoder (e.g., video decoder 300 or in some examples, prediction processing unit 304 of video decoder 300) may determine, based on a height of a current block and/or a width of the current block and based on a filter index value for UDDF, a filter type for UDDF (e.g., a horizontal filter, a vertical filter, etc.) in FIG. 11.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first horizontal filter and/or a first vertical filter for UDDF) when a current block has a first block size (e.g., block sizes having more than 64 samples). In this example, the video decoder may interpret the filter index value of the particular value (e.g., ‘1’) as representing a second filter type (e.g., having a second horizontal filter and/or a second vertical filter for UDDF) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

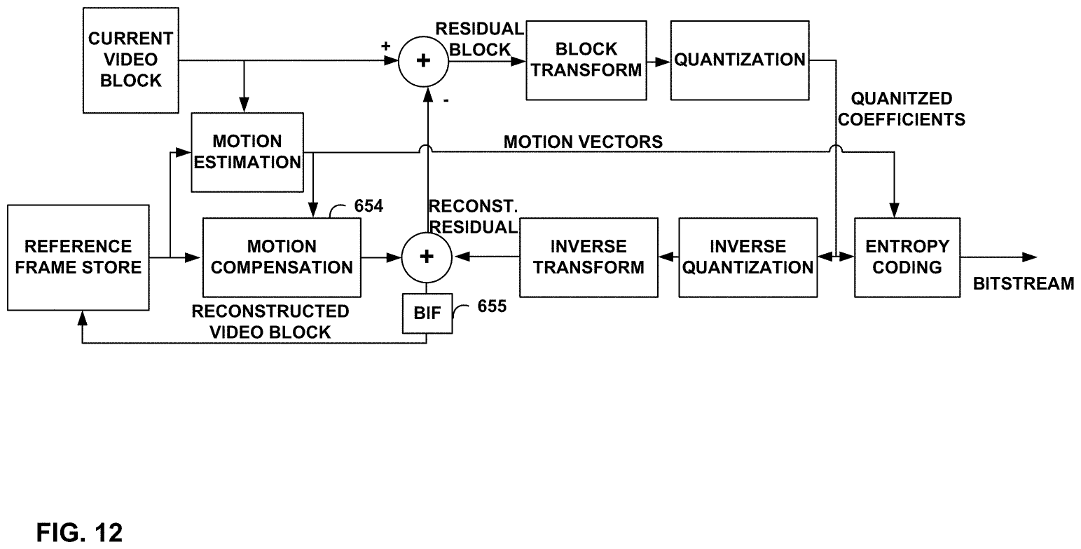

FIG. 12 is a conceptual diagram illustrating an inter prediction chain of a hybrid video codec with post reconstruction following motion compensation 654. In some examples, a video coder (e.g., video encoder 200 or video decoder 300) may be configured to apply in-loop filtering in the reconstruction sample domain, in the chain preceding SAO, deblocking, and adaptive loop filtering (ALF). An example of in-loop filtering may be found in Chen, et al. “Description of SDR, HDR and 360° video coding technology proposal by Qualcomm and Technicolor—low and high complexity versions,” Joint Video Experts Team (WET) of ITU-T SG 16 WP 3 and ISO/IEC JTC 1/SC 29/WG 11, 10th Meeting: San Diego, US, 10-20 Apr. 2018, WET-J0021-r1 (hereinafter “JVET-J0021”).

In the example of FIG. 12, a video coder (e.g., video encoder 200 or video decoder 300) applies a bilateral Filter (BIF) 655 in the reconstruction samples domain as an additional stage preceding loop filters, such as, for example, before deblocking and/or before applying an adaptive loop filter (ALF). BIF 655 is an example of filtering in the prediction domain. For example, filter type and/or filter parameters for BIF 655 may be signaled by video encoder 200 and decoded by video decoder 300.

A video coder (e.g., video encoder 200 or video decoder 300) may apply BIF 655 to luma blocks with non-zero transform coefficients and slice quantization parameter larger than 17. The video coder may apply a bilateral filter on reconstructed samples right after the inverse transform. The video coder may explicitly derive the filter parameters (e.g., weights) from the coded information.

An example filtering process is defined as:

P′_{0,0}=P_{0,0}+Σₖ₌₁^{K}Wₖ(abs(P_{k,0}−P_{0,0}))×(P_{k,0}−P_{0,0}), EQUATION 6

where P_{0,0} is the intensity of the current sample and P′_{0,0} is the modified intensity of the current sample, and P_{k,0} and Wₖ are the intensity and weighting parameter for the k-th neighboring sample, respectively.

Techniques for block dependent signaling may be used for signaling a filter type used for filtering (e.g., applying BIF) in the example of FIG. 12. For example, a video encoder (e.g., video encoder 200 or in some examples, mode selection unit 202 of video encoder 200) may determine, based on a height of a current block and/or a width of the current block and based on a filter type for BIF (e.g., weights), a filter index value for BIF (e.g., weights) in FIG. 12. A video decoder (e.g., video decoder 300 or in some examples, prediction processing unit 304 of video decoder 300) may determine, based on a height of a current block and/or a width of the current block and based on a filter index value for BIF, a filter type for BIF (e.g., weights) in FIG. 12.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for BIF) when a current block has a first block size (e.g., block sizes having more than 64 samples). In this example, the video decoder may interpret the filter index value of the particular value (e.g., ‘1’) as representing a second filter type (e.g., having a second weighting factor for BIF) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

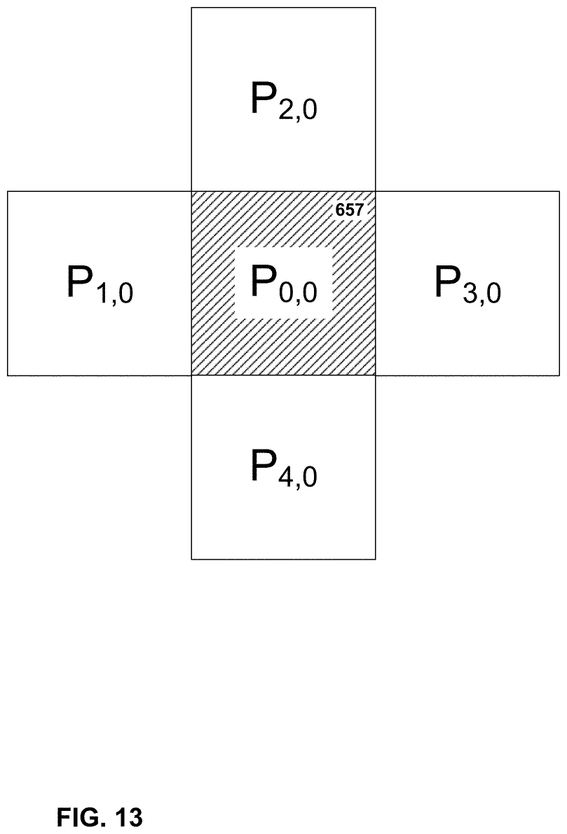

FIG. 13 is a conceptual diagram illustrating neighboring samples utilized in a bilateral filter. An example of a current sample 657 and four neighboring samples (e.g., K=4) of current sample 657 is depicted in FIG. 13. More specifically, the weight Wₖ(x) of a bilateral filter and associated with the k-th neighboring sample is defined as follows:

$$\begin{matrix}{W}_{k} ( x ) = {Distance}_{k} \times {Range}_{k} ( x ) & EQUATION 7 \\ {Distance}_{k} = {e}^{( - \frac{10000}{2 {σ}_{d}^{2}} )} / 1 + 4 * {e}^{( - \frac{10000}{2 {σ}_{d}^{2}} )} , & EQUATION 8 \\ {Range}_{k} ( x ) = {e}^{( - \frac{{x}^{2}}{8 * ( QP - 17 ) * ( QP - 17 )} )} & EQUATION 9\end{matrix}$$

where k is a neighboring sample (e.g., 1, 2, 3, or 4), x is a decoded sample value (e.g., decoded right after an inverse transform), Wₖ(x) is a weight of a bilateral filter associated with the k-th neighboring sample of the decoded sample value x, a_{d} is dependent on the coded mode and coding block sizes, and QP is a quantization parameter (e.g., at a slice that includes the decoded sample value x). The described filtering process is applied to intra-coded blocks and inter-coded blocks when TU is further split, to enable parallel processing.

To better capture statistical properties of video signal, and improve performance of the filter, a video coder (e.g., video encoder 200 or video decoder 300) may be configured to adjust the weights function resulting from Equation 8 by the σ_{d} parameter, tabulated in a table provided to a video decoder (e.g., video decoder 300 or in some examples, prediction processing unit 304 of video decoder 300) as side information and being dependent on a coding mode and parameters for a block partitioning (e.g., a minimal size). The weight functions of Equations 7-9 (e.g., σ_{d}) may represent example filter parameters of a filter type that may be signaled by video encoder 200 and decoded by video decoder 300.

On the block boundaries, a video coder (e.g., video encoder 200 or video decoder 300) may extend the predicted signal by using UDDF (see FIG. 11), with the diffusion filter.

When available, a video coder (e.g., video encoder 200 or video decoder 300) may use the neighboring reconstructed information. The video coder may check the availability of the neighboring samples every 4 samples (or every MIN_PU_SIZE samples, if different), on the left and above boundaries of the block. In this way, when only part of the neighboring information is available, the video coder may use the available part of the neighboring information. When not available, the video coder may mirror the predicted block to fill the extended predicted block.

Techniques for block dependent signaling may be used for signaling a filter type used for filtering (e.g., applying bilateral filtering) in the example of FIG. 13. For example, a video encoder (e.g., video encoder 200 or in some examples, mode selection unit 202 of video encoder 200) may determine, based on a height of a current block and/or a width of the current block and based on a filter type for bilateral filtering (e.g., weights), a filter index value for bilateral filtering in FIG. 13. A video decoder (e.g., video decoder 300 or in some examples, prediction processing unit 304 of video decoder 300) may determine, based on a height of a current block and/or a width of the current block and based on a filter index for bilateral filtering, a filter type for bilateral filtering (e.g., weights) in FIG. 13.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for BIF) when a current block has a first block size (e.g., block sizes having more than 64 samples). In this example, the video decoder may interpret the filter index value of the particular value (e.g., ‘1’) as representing a second filter type (e.g., having a second weighting factor for BIF) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

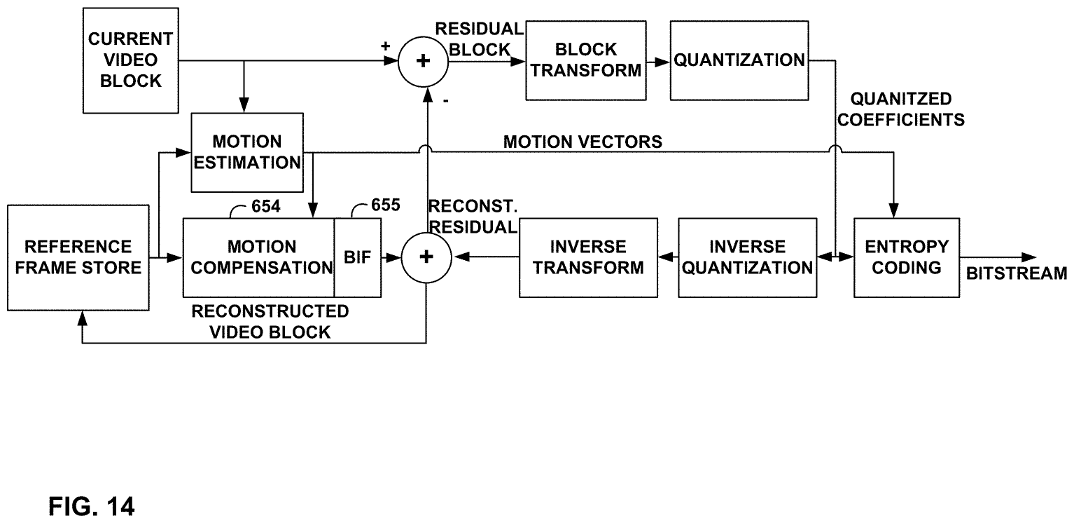

FIG. 14 is a conceptual diagram illustrating inter prediction chain of a hybrid video codec with post reconstruction following the motion compensation stage. In the example of FIG. 14, a video coder (e.g., video encoder 200 or video decoder 300) may implement a bilateral filter 655 and/or motion compensation 654 in the prediction domain, where the diffusion filter is performed. BIF 655 is an example of filtering in the prediction domain. For example, filter type and/or filter parameters for BIF 655 may be signaled by video encoder 200 and decoded by video decoder 300.

In some examples, a video coder (e.g., video encoder 200 or video decoder 300) may apply BIF 655 to luma blocks with non-zero transform coefficients and slice quantization parameter larger than 17. The video coder may apply BIF 655 on prediction samples. The video coder may explicitly derive the filter parameters (e.g., weights) from the coded information. The filtering process may be identical to bilateral filter (e.g., BIF 655) in the reconstructed domain.

Techniques for block dependent signaling may be used for signaling a filter type used for filtering (e.g., applying BIF) in the example of FIG. 14. For example, a video encoder (e.g., video encoder 200 or in some examples, mode selection unit 202 of video encoder 200) may determine, based on a height of a current block and/or a width of the current block and based on a filter type for BIF (e.g., weights), a filter index value for BIF in FIG. 14. A video decoder (e.g., video decoder 300 or in some examples, prediction processing unit 304 of video decoder 300) may determine, based on a height of a current block and/or a width of the current block and based on a filter index value for BIF, a filter type for BIF (e.g., weights) in FIG. 14.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for BIF) when a current block has a first block size (e.g., block sizes having more than 64 samples). In this example, the video decoder may interpret the filter index value of the particular value (e.g., ‘1’) as representing a second filter type (e.g., having a second weighting factor for BIF) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

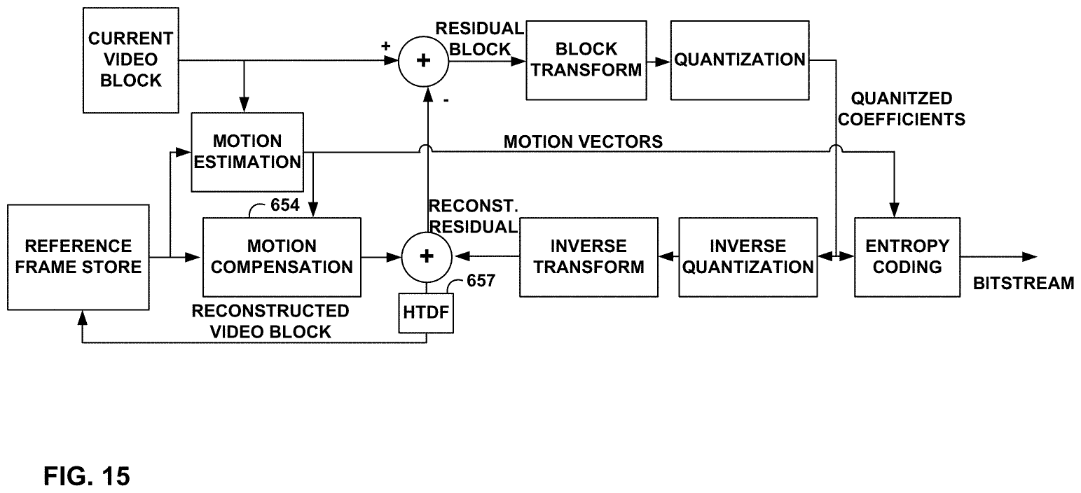

FIG. 15 is a conceptual diagram illustrating inter prediction chain of the hybrid video codec with post reconstruction following the motion compensation stage. In the example of FIG. 15, a video coder (e.g., video encoder 200 or video decoder 300) may apply a Hadamard transform domain filter 657 (HTDF) to luma reconstructed blocks right after block reconstruction. An example of a Hadamard transform domain filter is described in Ikonin, et al. “CE14: Hadamard transform domain filter (Test 3),” Joint Video Experts Team (JVET) of ITU-T SG 16 WP 3 and ISO/IEC JTC 1/SC 29/WG 11, 12th Meeting: Macao, CN, 3-12 Oct. 2018, WET-L326-v3 (hereinafter “JVET-L326”).

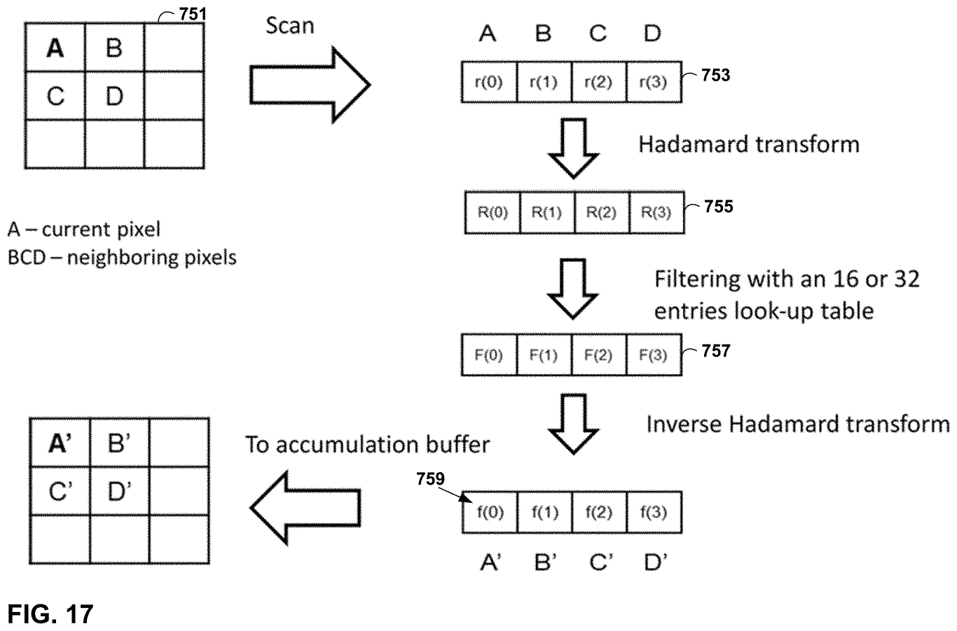

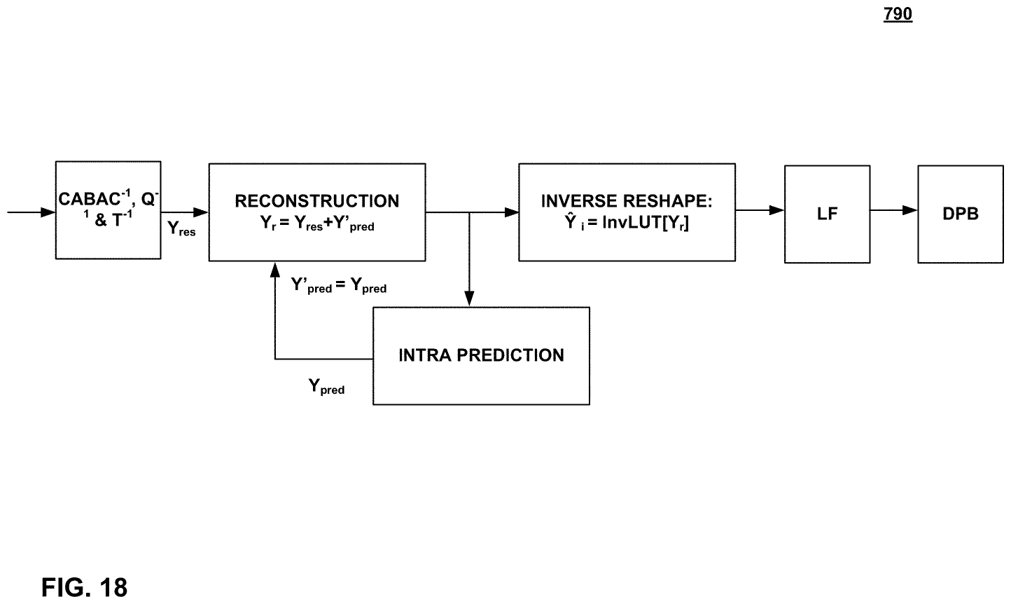

For each pixel from reconstructed block pixel, a video coder (e.g., video encoder 200 or video decoder 300) may apply HTDF 657, which is described in further detail with respect to FIGS. 17, 18. HTDF 657 is an example of filtering in the prediction domain. For example, filter type and/or filter parameters for HTDF 657 may be signaled by video encoder 200 and decoded by video decoder 300.

Techniques for block dependent signaling may be used for signaling a filter type used for filtering (e.g., applying HTDF) in the example of FIG. 15. For example, a video encoder (e.g., video encoder 200 or in some examples, mode selection unit 202 of video encoder 200) may determine, based on a height of a current block and/or a width of the current block and based on a filter type for HTDF (e.g., weights), a filter index value for HTDF in FIG. 15. A video decoder (e.g., video decoder 300 or in some examples, prediction processing unit 304 of video decoder 300) may determine, based on a height of a current block and/or a width of the current block and based on a filter index value, a filter type indicated for HTDF (e.g., weights) in FIG. 15.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for HTDF) when a current block has a first block size (e.g., block sizes having more than 64 samples). In this example, the video decoder may interpret the filter index value of the particular value (e.g., ‘1’) as representing a second filter type (e.g., having a second weighting factor for HTDF) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

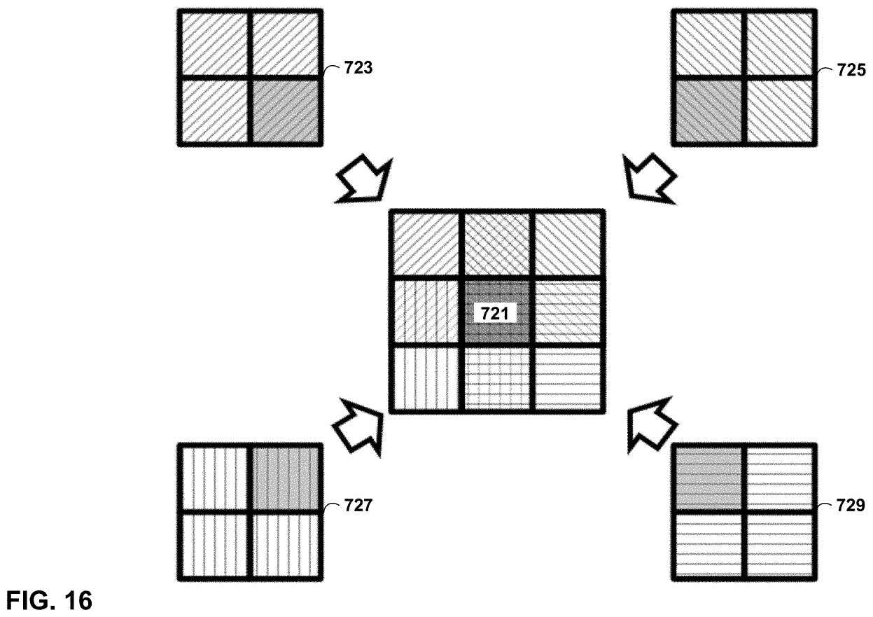

FIG. 16 is a conceptual diagram illustrating an example filtering process. Quantization conducted on transform coefficients of the coded block or on transform coefficients of residual block may result in quantization artifacts introduced to the block of data.

In the case of blocking artifacts, one of such quantization artifacts mentioned above, the horizontal and vertical discontinuities that do not exist in the original picture (note that a picture can be a still image or a frame from a video sequence) may be caused by moderate to high compression. These artifacts in flat areas look like “tiling,” because these artifacts are not masked by highly contrasted content. Furthermore, the blocking artifacts in a playing video may be observed as “moving and flickering,” because the discontinuities are located differently in successive frames.

One source of blocking artifacts is the block-based transform coding, including transform and quantization, on intra and inter prediction errors. Coarse quantization of the transform coefficients can cause visually disturbing discontinuities at the block boundaries. Motion compensated prediction is another source of blocking artifacts in videos. Motion compensated blocks may be generated by copying interpolated pixel data from different locations of possibly different reference frames. Because there is almost never a perfect fit for these data, discontinuities on the boundaries of the copied blocks of data typically arise.

Quantization noise introduced to the signal by scalar quantization of transform coefficients may result in introducing quantization noise to the reconstructed signal. To suppress this noise and recover the original signal, various filter designs have been proposed. One example of such filter designs is deblocking filter. Another example of such filtering designs is filtering in a transform domain to block artifact suppression, such as, for example, but not limited to, filtering in Sliding Window 3D DCT algorithm (SW-3DDCT) techniques for Gaussian noise suppression. Yet another example of transform domain filtering is a Hadamard transform filtering proposed for video coding. A brief description of Hadamard transform filtering is provided below.

In the example of FIG. 16, a video coder (e.g., video encoder 200 or video decoder 300) may be configured to generate a first filtered value for pixel 721 using a first set of samples 723 arranged within a 2×2 window positioned for a top-left group of samples that includes pixel 721. In this example, the video coder may be configured to generate a second filtered value for pixel 721 using a second set of samples 725 arranged within the 2×2 window positioned for a top-right group of samples that includes pixel 721. The video coder may be configured to generate a third filtered value for pixel 721 using a third set of samples 727 arranged within the 2×2 window positioned for a bottom-left group of samples that includes pixel 721. Further, the video coder may be configured to generate a fourth filtered value for pixel 721 using a fourth set of samples 729 arranged within the 2×2 window positioned for a bottom-right group of samples that includes pixel 721. The video coder may generate an averaged value for pixel 721 using the first filtered value, the second filtered value, the third filtered value, and the fourth filtered value. In this way, Hadamard transform filtering may help to reduce blocking artifacts and/or quantization noise.

In Hadamard transform filtering, a video coder (e.g., video encoder 200 or video decoder 300) may apply the filter to reconstructed blocks with non-zero transform coefficients. The video coder may perform the filter on decoded samples right after block reconstruction. For example, the video coder may be configured to receive a bitstream including encoded video data and decode, from a bitstream, values for one or more syntax elements to generate a residual block for a current block, prediction information for the current block, and transform domain filtering information. In this example, the video coder may be configured to reconstruct the current block using the prediction information and the residual block to generate a reconstructed block. In some examples, a video encoder (e.g., video encoder 200 or in some examples, mode selection unit 202 of video encoder 200) may be configured to reconstruct a current block using prediction information and a residual block to generate a reconstructed block. In this example, the video encoder may be configured to encode a bitstream for the video data, the bitstream including syntax elements indicating the prediction information, the residual block, and transform domain filtering information that indicates transform domain filtering is enabled for the current block. The video coder may use the filtered result both for output as well as for spatial and temporal prediction. The filter may have a same implementation both for intra and inter CU filtering.

For example, for each pixel from a reconstructed block, pixel processing may include one or more of the following steps to perform transform domain filtering on reconstructed blocks. In a first step, a video coder (e.g., video encoder 200 or video decoder 300) assembles samples of local neighborhood size of 2×2 with a current pixel included in the 2×2 windows. For example, the video coder may be configured to generate a set of samples for a pixel of the reconstructed block. The video coder may conduct sample assembly according to a specified pattern.

In a second step, a video coder (e.g., video encoder 200 or video decoder 300) may conduct an assembly of four samples using a 4-point Hadamard transform. In a third step, the video coder may conduct transform domain filtering by non-uniform thresholding and filter coefficient scaling as follows,

$$F ( i , σ ) = \frac{{R ( i )}^{2}}{{R ( i )}^{2} + m * {σ}^{2}} * R ( i ) \qquad EQUATION 10$$

wherein (i) is an index of a spectrum component in a Hadamard spectrum, R(i) represents spectrum components of reconstructed pixels corresponding to index, m=4 is a normalization constant equal to number of spectrum components, and σ is a filtering parameter deriving from a codec quantization parameter QP using Equation 11.

σ=2.64*2^{(0.1296*(QP-11))} EQUATION 11

Said differently, for example, a video coder (e.g., video encoder 200 or video decoder 300) may perform a transform on the set of samples for the pixel from a pixel domain to a frequency domain to generate spectrum components of reconstructed pixels and filter the spectrum components of the reconstructed pixels to generate a filtered spectrum components of the reconstructed pixels.

The first spectrum component corresponding to a DC value may be bypassed without filtering. In some examples, a video coder (e.g., video encoder 200 or video decoder 300) may perform an inverse 4-point Hadamard transform of a filtered spectrum. In some examples, after performing a filtering step, the video coder may place the filtered pixels into original positions of an accumulation buffer. In some examples, after completing filtering of pixels, the video coder may normalize the accumulated values by number of processing windows 2×2 used for each pixel filtering.

Techniques for block dependent signaling may be used for signaling a filter type used for filtering (e.g., applying Hadamard filtering) in the example of FIG. 16. For example, a video encoder (e.g., video encoder 200 or in some examples, mode selection unit 202 of video encoder 200) may determine, based on a height of a current block and/or a width of the current block and based on a filter type for Hadamard filtering (e.g., weights), a filter index value for Hadamard filtering (e.g., weights) in FIG. 16. A video decoder (e.g., video decoder 300 or in some examples, prediction processing unit 304 of video decoder 300) may determine, based on a height of a current block and/or a width of the current block and based on a filter index value for Hadamard filtering, a filter type for Hadamard filtering (e.g., weights) in FIG. 16.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for Hadamard filtering) when a current block has a first block size (e.g., block sizes having more than 64 samples). In this example, the video decoder may interpret the filter index value of the particular value (e.g., ‘1’) as representing a second filter type (e.g., having a second weighting factor for Hadamard filtering) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

FIG. 17 is a conceptual diagram illustrating a filtering process. An equivalent filter shape is a 3×3 block of pixels 751, as depicted in FIG. 17. The transform domain filtering process specified in Equation 10 introduces a multiplication of spectrum component R(i) on a scaling coefficient which is always less than 1. To exclude multiplication, a LUT based transfer function may be used as shown in Equation 12.

$$F ( i , σ ) = \{ \begin{matrix}R ( i ) , Abs ( R ( i ) ) \geq THR \\ LUT ( R ( i ) , σ ) , R ( i ) > 0 \\ - LUT ( - R ( i ) , σ ) , R ( i ) \leq 0\end{matrix} \qquad EQUATION 12$$

### In Equation 12, LUT(R(i),

$$σ ) = \frac{{R ( i )}^{3}}{{R ( i )}^{2} + m * {σ}^{2}} .$$

where (i) is index of spectrum component in Hadamard spectrum, σ is defined in Equation 11, abs( ) is a function that returns an absolute value, R(i) are spectrum components of reconstructed pixels corresponding to index, and m=4 is a normalization constant equal to a number of spectrum components.

Said differently, for example, a video coder (e.g., video encoder 200 or video decoder 300) may assemble (e.g., scan, generate, etc.) a set of samples 753 for a pixel (e.g., A) of the reconstructed block, perform a transform on the set of samples for the pixel from a pixel domain to a frequency domain to generate spectrum components 755 of reconstructed pixels and filter the spectrum components 755 of the reconstructed pixels to generate filtered spectrum components 757 of the reconstructed pixels. In this example, the transform is a Hadamard transform; however, in other examples, other transforms may be used.

A video coder (e.g., video encoder 200 or video decoder 300) may apply an inverse Hadamard transform to the filtered spectrum components of the reconstructed pixels. In this example, in other examples, other inverse transforms may be used. For example, the video coder may perform an inverse transform on filtered spectrum components 757 of the reconstructed pixels from the frequency domain to the pixel domain to generate a filtered value 759 for the pixel (e.g., A′).

A video coder (e.g., video encoder 200 or video decoder 300) may repeat this process for all 2×2 areas containing the sample and may average the result. For example, the video coder may be configured to generate a first filtered value for the pixel using a first set of samples 723 for a pixel, generate a second filtered value for the pixel using a second set of samples 725 for the pixel, generate a third filtered value for the pixel using a third set of samples 727 for the pixel, and generate a fourth filtered value for the pixel using a fourth set of samples 729 for the pixel and average the first filtered value, the second filtered value, the third filtered value, and the fourth filtered value to generate an averaged value for the pixel.

For sample x, a video coder (e.g., video encoder 200 or video decoder 300) may process four blocks 2×2 via spectrum X1 for top-left group of samples, X2 for top-right, X3 for bottom-left and X4 for bottom-right group of samples. The output value produced by the inverse Hadamard transform from scaled coefficients form an estimate Xi (e.g., X1, X2, X3, X4), and output value y is produced by averaging for estimates. For example, the video coder may calculate Equation 13 to generate the output value y.

y=(invT(TF(X1))+invT(TF(X2))+invT(TF(X3))+invT(TF(X4)))/4 EQUATION 13

where Xi are transform coefficients, TF is a transfer function, and invT is a process of inverse transformation.

That is, for example, a video coder (e.g., video encoder 200 or video decoder 300) may be configured to repeat the process for each set of samples for the pixel. For instance, the video coder may be configured to generate a second set of samples for the pixel. The video coder may be configured to perform the transform on the second set of samples for the pixel from the pixel domain to the frequency domain to generate second spectrum components of the reconstructed pixels. In this example, the video coder may be configured to filter the second spectrum components of the reconstructed pixels to generate second filtered spectrum components of the reconstructed pixels. The video coder may be configured to perform the inverse transform on the second filtered spectrum components of the reconstructed pixels from the frequency domain to the pixel domain to generate a second filtered value for the pixel.

A video coder (e.g., video encoder 200 or video decoder 300) may use a look-up table to approximate any of the transfer functions in Equations 10-12. In some examples, the video coder may only tabulate positive values. For values larger than 127, the video coder may use the approximation F(x)=x instead. Furthermore, in some examples, the video coder may not tabulate every value between 0 and 127. For example, the video coder may use subsampling, such that a total of N (32 or 16) values are used.

Techniques for block dependent signaling may be used for signaling a filter type used for filtering (e.g., applying Hadamard filtering) in the example of FIG. 17. For example, a video encoder (e.g., video encoder 200 or in some examples, mode selection unit 202 of video encoder 200) may determine, based on a height of a current block and/or a width of the current block and based on a filter type for Hadamard filtering (e.g., weights), a filter index value for Hadamard filtering in FIG. 17. A video decoder (e.g., video decoder 300 or in some examples, prediction processing unit 304 of video decoder 300) may determine, based on a height of a current block and/or a width of the current block and based on a filter index value for Hadamard filtering, a filter type for Hadamard filtering (e.g., weights) in FIG. 17.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for Hadamard filtering) when a current block has a first block size (e.g., block sizes having more than 64 samples). In this example, the video decoder may interpret the filter index value of the particular value (e.g., ‘1’) as representing a second filter type (e.g., having a second weighting factor for Hadamard filtering) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

FIG. 18 is a conceptual drawing illustrating intra slice reconstruction 790 with an in-loop luma reshaper (e.g., the three left-most blocks in FIG. 18 indicate a signal in a reshaped domain: luma residue; intra luma predicted; and intra luma reconstructed). An example in-loop processing module may be found in Kotra, et al. “CE11-related: Position dependent adaptive Tc clipping range for deblocking filter,” Joint Video Experts Team (WET) of ITU-T SG 16 WP 3 and ISO/IEC JTC 1/SC 29/WG 11, 12th Meeting: Macao, CN, 3-12 Oct. 2018, JVET-L24641 (hereinafter “JVET-L246”) and in Skupin, et al. “AHG 12: Sub-bitstream extraction/merging friendly slice address signalling,” Joint Video Experts Team (WET) of ITU-T SG 16 WP 3 and ISO/IEC JTC 1/SC 29/WG 11, 12th Meeting: Macao, CN, 3-12 Oct. 2018, WET-L247-r1 (hereinafter “JVET-L247”). In the example of FIG. 18, a video coder (e.g., video encoder 200 or video decoder 300) may use an in-loop luma reshaper as a pair of look-up tables (LUTs), which are approximately invertible and defined by a single set of piece-wise linear parameters.

A video coder (e.g., video encoder 200 or video decoder 300) may be configured to implement a LUT as a one-dimensional, 10-bit, 1024-entry mapping table (1D-LUT). One LUT may be a forward LUT, FwdLUT, that maps input luma code values Yᵢ to altered values Yᵣ:Yᵣ=FwdLUT [Yᵢ]. The other LUT may be an inverse LUT, InvLUT, that maps altered code values Yᵣ to Ŷᵢ:Ŷᵢ=InvLUT [Yᵣ]. (Ŷᵢ represents the reconstruction values of Yᵢ.)

For intra slices, a video coder (e.g., video encoder 200 or video decoder 300) may apply only the InvLUT. For inter slices, the video coder may apply both FwdLUT and InvLUT. The video coder may apply LUTs before loop filtering for both intra and inter slices. Processing operations and data flow may be identical for SDR and HDR. The slice reconstruction with in-loop luma of FIG. 18 is an example of filtering in the prediction domain. For example, filter type and/or filter parameters of FIG. 18 may be signaled by video encoder 200 and decoded by video decoder 300.

The slice reconstruction of FIG. 18 is an example of filtering in the prediction domain. For example, filter type and/or filter parameters of FIG. 18 may be signaled by video encoder 200 and decoded by video decoder 300.

A video coder (e.g., video encoder 200 or video decoder 300) may be configured to perform one or more steps of FIG. 18. The processing operations for intra slices are illustrated in FIG. 18. InvLUT maps intra reconstructed values in the reshaped domain to intra reconstructed values in the original domain. (Ŷᵢ=InvLUT[Yᵣ]).

Techniques for block dependent signaling may be used for signaling a filter type used for reshaping (e.g., applying intra slice reconstruction with an in-loop luma reshaper) in the example of FIG. 18. For example, a video encoder (e.g., video encoder 200 or in some examples, mode selection unit 202 of video encoder 200) may determine, based on a height of a current block and/or a width of the current block and based on a filter type for applying intra slice reconstruction with an in-loop luma reshaper (e.g., weights), a filter index value for applying intra slice reconstruction with an in-loop luma reshaper in FIG. 18. A video decoder (e.g., video decoder 300 or in some examples, prediction processing unit 304 of video decoder 300) may determine, based on a height of a current block and/or a width of the current block and based on a filter index value for applying intra slice reconstruction with an in-loop luma reshaper, a filter type for applying intra slice reconstruction with an in-loop luma reshaper (e.g., weights) in FIG. 18.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for an in-loop luma reshaper) when a current block has a first block size (e.g., block sizes having more than 64 samples). In this example, the video decoder may interpret the filter index value of the particular value (e.g., ‘1’) as representing a second filter type (e.g., having a second weighting factor for the in-loop luma reshaper) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

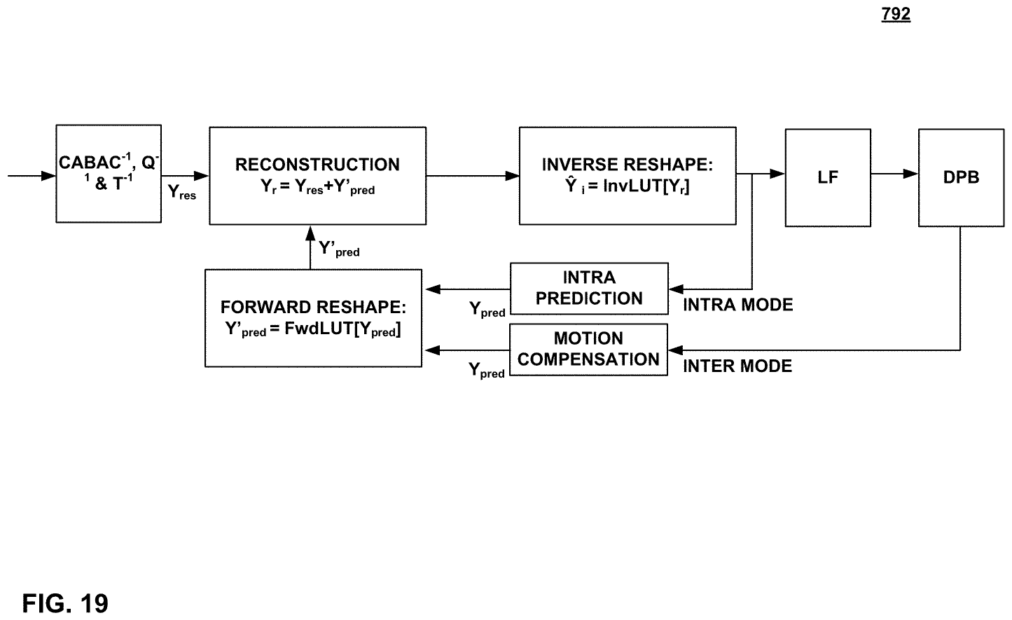

FIG. 19 is a conceptual drawing illustrating inter slice reconstruction with in-loop luma reshaper 792. The slice reconstruction of FIG. 19 is an example of filtering in the prediction domain. For example, filter type and/or filter parameters of FIG. 19 may be signaled by video encoder 200 and decoded by video decoder 300.

A video coder (e.g., video encoder 200 or video decoder 300) may be configured to perform one or more steps of FIG. 19. The processing operations for inter slices are illustrated in FIG. 19. FwdLUT maps motion-compensation values in the original domain to the reshaped domain. (FwdLUT[Y_{pred}]). InvLUT then maps inter reconstructed values in the reshaped domain to inter reconstructed values in the original domain. (Ŷᵢ=InvLUT[Yᵣₑₛ+FwdLUT [Y_{pred}]]).

The reshaper model syntax may cause a video coder (e.g., video encoder 200 or video decoder 300) to signal a piece-wise linear (PWL) model with 32 equal pieces. The video coder may use the PWL model to precompute the 1024-entry FwdLUT and InvLUT mapping tables. Using the PWL model may also allow the video coder to calculate identical mapping values on-the-fly without pre-computing the LUTs). Conceptually, a video coder (e.g., video encoder 200 or video decoder 300) may be configured to implement PWL as follows.

Let x1, x2 be two input pivot points, and y1, y2 be their corresponding output pivot points for one piece. A video coder (e.g., video encoder 200 or video decoder 300) may be configured to interpolate the output value y for any input value x between x1 and x2 by the following equation:

y=((y2−y1)/(x2−x1))*(x−x1)+y1 EQUATION 14

In fixed point implementation, Equation 14 can be rewritten as follows.

y=((m*x+2^{FP_PREC-1})>>FP_PREC)+c

where m is scalar, c is an offset, and FP_PREC is a constant value to specify the precision.

For intra TUs in inter slices, a video coder (e.g., video encoder 200 or video decoder 300) may move the inverse reshape module out of the critical intra prediction loop in inter slice decoding. The video coder may always perform intra prediction in reshaped domain regardless of slice type. With such arrangement, the video coder may start intra prediction start immediately after previous TU reconstruction is done. Such an arrangement can also provide a unified process for intra mode instead of being slice dependent.

Techniques for block dependent signaling may be used for signaling a filter type used for reshaping (e.g., applying inter slice reconstruction with an in-loop luma reshaper) in the example of FIG. 19. For example, a video encoder (e.g., video encoder 200 or in some examples, mode selection unit 202 of video encoder 200) may determine, based on a height of a current block and/or a width of the current block and based on a filter type for applying inter slice reconstruction with an in-loop luma reshaper (e.g., weights), a filter index value indicating a filter type for applying inter slice reconstruction with an in-loop luma reshaper in FIG. 19. A video decoder (e.g., video decoder 300 or in some examples, prediction processing unit 304 of video decoder 300) may determine, based on a height of a current block and/or a width of the current block and based on a filter index value for filter type for applying inter slice reconstruction with an in-loop luma reshaper, a filter type for applying inter slice reconstruction with an in-loop luma reshaper (e.g., weights) in FIG. 19.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for an in-loop luma reshaper) when a current block has a first block size (e.g., block sizes having more than 64 samples). In this example, the video decoder may interpret the filter index value of the particular value (e.g., ‘1’) as representing a second filter type (e.g., having a second weighting factor for the in-loop luma reshaper) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

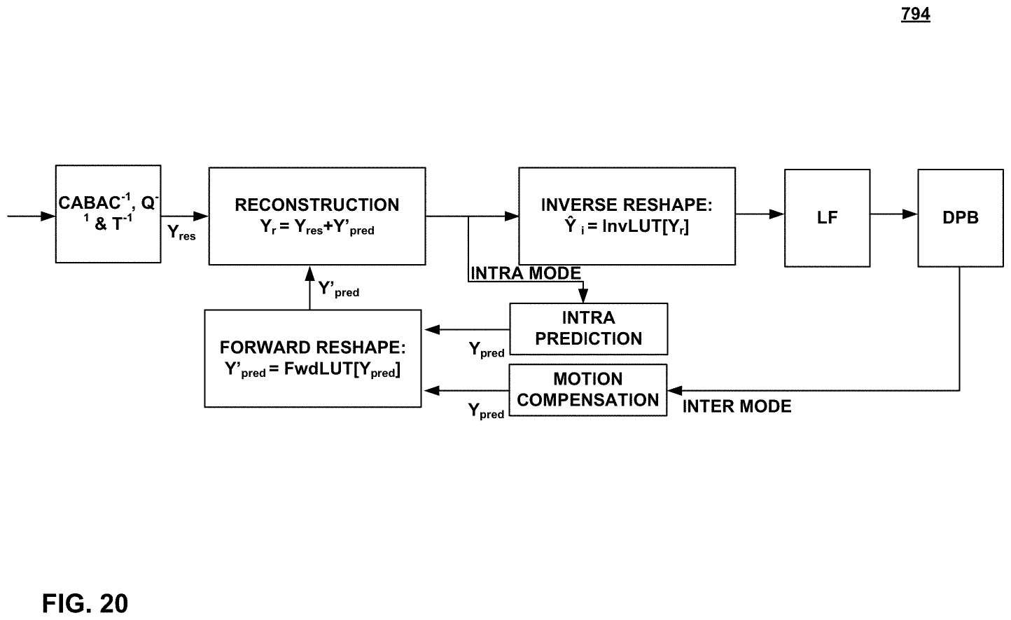

FIG. 20 is a conceptual drawing illustrating inter slice reconstruction with in-loop luma reshaper 794 (CABAC⁻¹, Reconstruction, and Intra Prediction blocks indicate signal in reshaped domain: luma residue; intra luma predicted; and intra luma reconstructed). The slice reconstruction of FIG. 20 is an example of filtering in the prediction domain. For example, filter type and/or filter parameters of FIG. 20 may be signaled by video encoder 200 and decoded by video decoder 300.

A difference of operational domains between CE12-2 and CE12-1 is the intra prediction in inter slices. In addition, in CE12-2, the FwdLUT of inter predicted signal can be subsumed as part of motion compensation. Thus, the reconstruction pipeline is only affected by the InvLUT of the reconstructed sample, which only needs to happen any time before loop filtering, and hence is not in the critical path. Table 3 lists the operational domains in CE12-1 and CE12-2 and explains how combined merge and intra prediction (e.g., a multi-hypothesis prediction) is performed.

TABLE 3
Explanation of operational domains in CE12-1 and CE12-2

| CE12-1 | CE12-1 |
|---|---|
| Intra Prediction (IP) in intra | Reshaped domain |
| slice | |
| Intra Prediction (IP) in inter | Reshaped domain |
| slice | |
| Inter Prediction (MC) | Original domain |
| Loop Filtering | Original domain |
| Combined merge and intra | IP in reshaped domain, MC |
| prediction | in original domain. |
| | Combined predicted signal |
| | obtained from IP and |
| | FwdLUT applied MC |

Techniques for block dependent signaling may be used for signaling a filter type used for reshaping (e.g., applying inter slice reconstruction with an in-loop luma reshaper) in the example of FIG. 20. For example, a video encoder (e.g., video encoder 200 or in some examples, mode selection unit 202 of video encoder 200) may determine, based on a height of a current block and/or a width of the current block and based on a filter type for applying inter slice reconstruction with an in-loop luma reshaper (e.g., weights), a filter index value for applying inter slice reconstruction with an in-loop luma reshaper in FIG. 20. A video decoder (e.g., video decoder 300 or in some examples, prediction processing unit 304 of video decoder 300) may determine, based on a height of a current block and/or a width of the current block and based on a filter index value for applying inter slice reconstruction with an in-loop luma reshaper, a filter type indicated by a filter index value for applying inter slice reconstruction with an in-loop luma reshaper (e.g., weights) in FIG. 20.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for an in-loop luma reshaper) when a current block has a first block size (e.g., block sizes having more than 64 samples). In this example, the video decoder may interpret the filter index value of the particular value (e.g., ‘1’) as representing a second filter type (e.g., having a second weighting factor for the in-loop luma reshaper) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

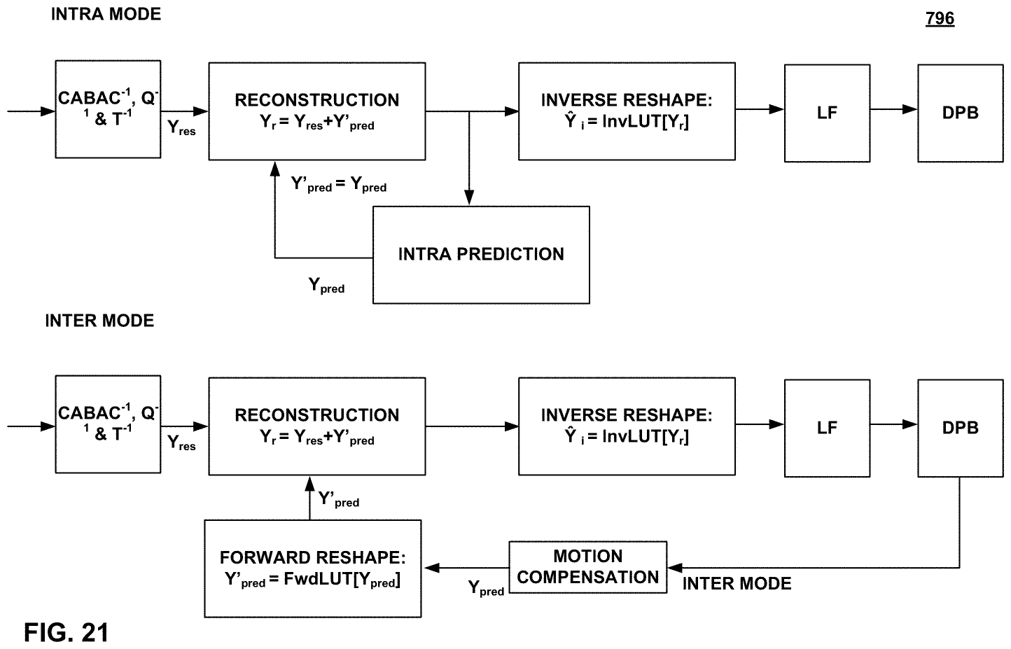

FIG. 21 is a conceptual drawing illustrating intra mode and inter mode reconstruction with in-loop luma reshaper 796 (the CABAC⁻¹, Reconstruction, and Intra Prediction blocks indicate a signal in a reshaped domain: luma residue; intra luma predicted; and intra luma reconstructed). The slice reconstruction of FIG. 21 is an example of filtering in the prediction domain. For example, filter type and/or filter parameters of FIG. 21 may be signaled by video encoder 200 and decoded by video decoder 300.

Techniques for block dependent signaling may be used for signaling a filter type used for reshaping (e.g., applying inter mode and inter mode slice reconstruction with an in-loop luma reshaper) in the example of FIG. 21. For example, a video encoder (e.g., video encoder 200 or in some examples, mode selection unit 202 of video encoder 200) may determine, based on a height of a current block and/or a width of the current block and based on a filter type for applying inter mode and inter mode slice reconstruction with an in-loop luma reshaper (e.g., weights), a filter index value for applying inter mode and inter mode slice reconstruction with an in-loop luma reshaper in FIG. 21. A video decoder (e.g., video decoder 300 or in some examples, prediction processing unit 304 of video decoder 300) may determine, based on a height of a current block and/or a width of the current block and based on a filter index value for a filter type for applying inter mode and inter mode slice reconstruction with an in-loop luma reshaper, a filter type for applying inter mode and inter mode slice reconstruction with an in-loop luma reshaper (e.g., weights) in FIG. 21.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for an in-loop luma reshaper) when a current block has a first block size (e.g., block sizes having more than 64 samples). In this example, the video decoder may interpret the filter index value of the particular value (e.g., ‘1’) as representing a second filter type (e.g., having a second weighting factor for the in-loop luma reshaper) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

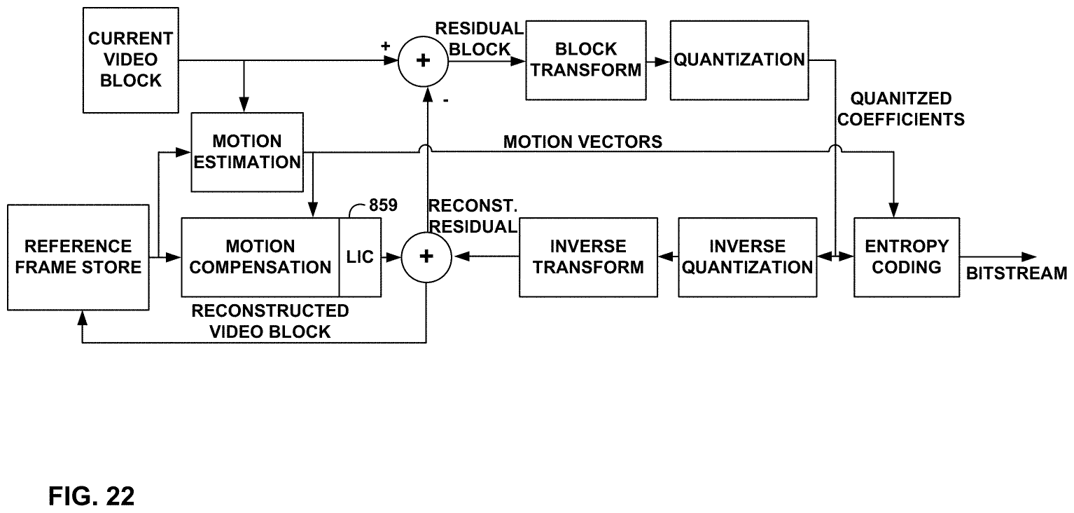

FIG. 22 is a conceptual drawing illustrating inter prediction chain of the hybrid video codec with Local Illumination Compensation (LIC) 859 following the motion compensation stage. The hybrid video codec with LIC 859 of FIG. 22 is an example of filtering in the prediction domain. For example, filter type and/or filter parameters of FIG. 22 may be signaled by video encoder 200 and decoded by video decoder 300.

In the example of FIG. 22, an in-loop processing module utilized in video coding design is uni-directional LIC 859 applied in the prediction domain, as shown in FIG. 22. An example of unidirectional illumination compensation can be found in Seregin, et al. “CE10-related: Unidirectional illumination compensation,” Joint Video Experts Team (WET) of ITU-T SG 16 WP 3 and ISO/IEC JTC 1/SC 29/WG 11, 13th Meeting: Marrakech, MA, 9-18 Jan. 2019, WET-M0500-v3 (hereinafter “WET-M0500”).

Techniques for block dependent signaling may be used for signaling a filter type used for LIC in the example of FIG. 22. For example, a video encoder (e.g., video encoder 200 or in some examples, mode selection unit 202 of video encoder 200) may determine, based on a height of a current block and/or a width of the current block and based on a filter type for applying LIC, a filter index value for applying LIC in FIG. 22. A video decoder (e.g., video decoder 300 or in some examples, prediction processing unit 304 of video decoder 300) may determine, based on a height of a current block and/or a width of the current block and based on a filter index value for applying LIC, a filter type for applying LIC in FIG. 22.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for LIC) when a current block has a first block size (e.g., block sizes having more than 64 samples). In this example, the video decoder may interpret the filter index value of the particular value (e.g., ‘1’) as representing a second filter type (e.g., having a second weighting factor for LIC) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

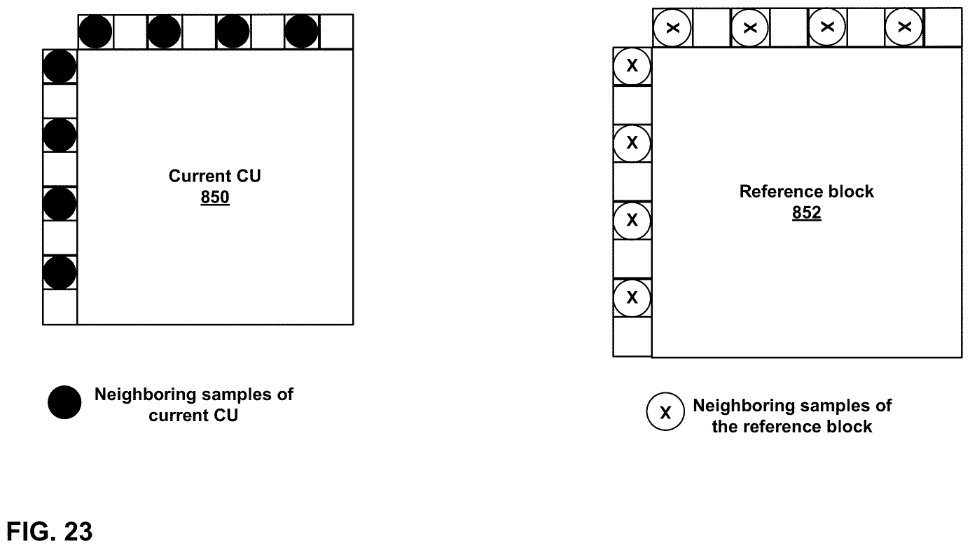

FIG. 23 is a conceptual drawing illustrating neighboring samples of a current block 850 and neighboring samples of a reference block 852. LIC is based on a linear model for illumination changes, using a scaling factor a and an offset b. A video coder (e.g., video encoder 200 or video decoder 300) may enable or disable LIC adaptively for each inter-mode coded coding unit (CU). The LIC of FIG. 23 is an example of filtering in the prediction domain. For example, filter type and/or filter parameters of FIG. 23 may be signaled by video encoder 200 and decoded by video decoder 300.

When LIC applies for a CU, a video coder (e.g., video encoder 200 or video decoder 300) may apply a least square error method to derive the parameters a and b by using the neighbouring samples of the current CU and the corresponding reference samples. More specifically, the video coder may use the subsampled (e.g., 2:1 subsampling) neighbouring samples of the CU and the corresponding samples (identified by motion information of the current CU or sub-CU) in the reference picture. The video coder may derive the IC parameters and apply the IC parameters for each prediction direction separately.

When a CU is coded with merge mode, a video coder (e.g., video encoder 200 or video decoder 300) may copy the LIC flag from neighbouring blocks, in a way similar to motion information copy in merge mode; otherwise, a video encoder (e.g., video encoder 200 or in some examples, mode selection unit 202 of video encoder 200) may signal a LIC flag for the CU to indicate whether LIC applies or not.

When LIC is enabled for a picture, a video coder (e.g., video encoder 200 or video decoder 300) may perform a CU level rate-distortion (RD) check to determine whether LIC is applied or not for a CU. When LIC is enabled for a CU, the video coder may use a mean-removed sum of absolute difference (MR-SAD) and mean-removed sum of absolute Hadamard-transformed difference (MR-SATD), instead of SAD and SATD, for integer pel motion search and fractional pel motion search, respectively.

To reduce the encoding complexity, a video coder (e.g., video encoder 200 or video decoder 300) may be configured to perform the following encoding scheme. The video coder may disable LIC for an entire picture when there is no obvious illumination change between a current picture and reference pictures of the current picture. To identify this situation, a video encoder (e.g., video encoder 200 or in some examples, mode selection unit 202 of video encoder 200) may calculate histograms of a current picture and every reference picture of the current picture. If the histogram difference between the current picture and every reference picture of the current picture is smaller than a given threshold, the video encoder may disable LIC for the current picture; otherwise, the video encoder may enable LIC for the current picture.

A video coder (e.g., video encoder 200 or video decoder 300) may keep the linear model parameters derivation unchanged and apply the LIC on a CU basis. In some examples, the video coder does not apply LIC to a sub-block based inter prediction, such as, for example, AMVP or affine, triangular partition, multi hypothesis intra inter, and bi-directional prediction.

Techniques for block dependent signaling may be used for signaling a filter type used for LIC in the example of FIG. 23. For example, a video encoder (e.g., video encoder 200 or in some examples, mode selection unit 202 of video encoder 200) may determine, based on a height of a current block and/or a width of the current block and based on a filter type for applying LIC (e.g., a weighting), a filter index value for applying LIC in FIG. 23. A video decoder (e.g., video decoder 300 or in some examples, prediction processing unit 304 of video decoder 300) may determine, based on a height of a current block and/or a width of the current block and based on a filter index value for applying LIC, a filter type for applying LIC (e.g., a weighting) in FIG. 23.

For example, a video coder (e.g., e.g., video encoder 200 or video decoder 300 or in some examples, mode selection unit 202 of video encoder 200, prediction processing unit 304 of video decoder 300) may determine a filter index value of a particular value (e.g., ‘1’) as representing a first filter type (e.g., having a first weighting factor for LIC) when a current block has a first block size (e.g., block sizes having more than 64 samples). In this example, the video decoder may interpret the filter index value of the particular value (e.g., ‘1’) as representing a second filter type (e.g., having a second weighting factor for LIC) when the current block has second block size (e.g., block sizes having less than 64 samples). In this way, the video coder may binarize and/or inverse binarize the filter type differently depending on a block size parameter (e.g., ratio of height to width, block size, etc.). Configuring the video coder for block dependent signaling may reduce an amount of information signaled in a bitstream compared to video encoders and video decoders that do not use block dependent signaling.

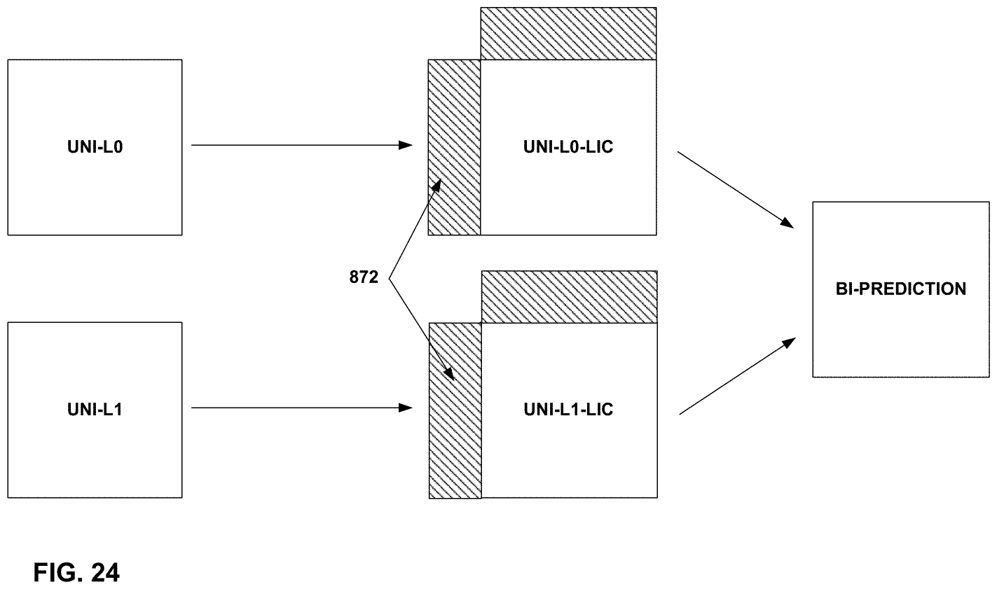

FIG. 24 is a conceptual drawing illustrating LIC with bi-prediction. The bi-prediction of FIG. 24 is an example of filtering in the prediction domain. For example, filter type and/or filter parameters of FIG. 24 may be signaled by video encoder 200 and decoded by video decoder 300.

A video coder (e.g., video encoder 200 or video decoder 300) may not apply LIC to bi-directional prediction because the reconstructed neighboring samples 872 of a current block are not required to perform inter prediction in the inter pipeline and thus may not be available for each uni-directional inter prediction, which otherwise would be required for LIC because the weighted average for bi-prediction is applied after deriving uni-directional predictors. Also, having LIC applied to bi-directional prediction may introduce an additional stage due to performing the LIC process before the weighting.

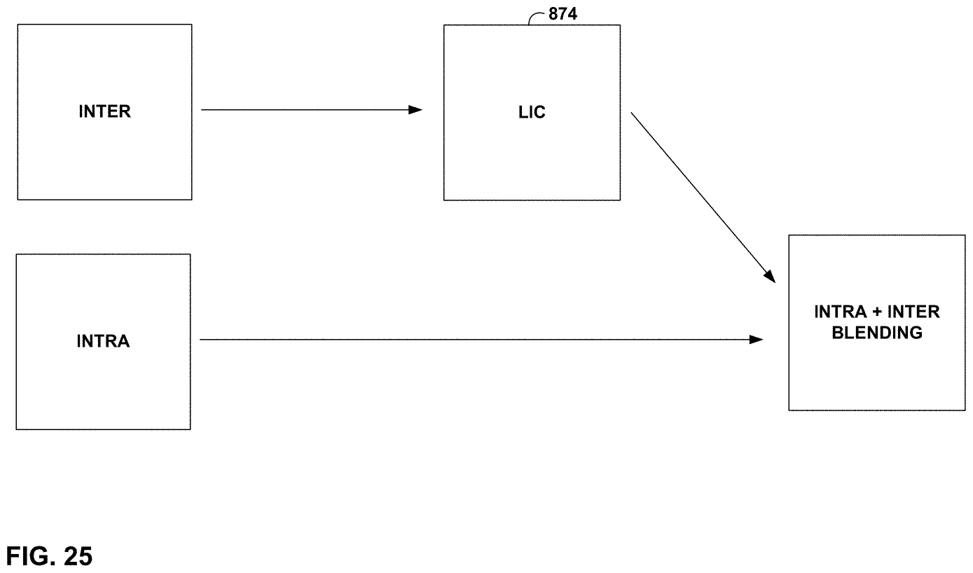

FIG. 25 is a conceptual drawing illustrating LIC with multi hypothesis intra-inter coding. The LIC of FIG. 25 is an example of filtering in the prediction domain. For example, filter type and/or filter parameters of FIG. 25 may be signaled by video encoder 200 and decoded by video decoder 300. For the same reasoning, a video coder (e.g., video encoder 200 or video decoder 300) may not apply LIC for multi hypothesis intra-inter coding because LIC 874 is applied after inter prediction and weighting between intra and inter would be delayed by the LIC process.

A LIC flag may be included as a part of motion information in addition to MVs and reference indices. However, when a merge candidate list is constructed, a video decoder (e.g., video encoder 200 or video decoder 300) may inherit the LIC flag from the neighbor blocks for merge candidates. The video coder may not use LIC for motion vector pruning.

A video coder (e.g., video encoder 200 or video decoder 300) may not store a LIC flag in the motion vector buffer of the reference picture. As such, the video coder may always set an LIC flag equal to false for temporal motion vector prediction (TMVP). The video coder may set the LIC flag equal to false for bi-directional merge candidates, such as, for example, pair-wise average candidates, and zero motion candidates. When a LIC tool is not applied, a video encoder (e.g., video encoder 200 or in some examples, mode selection unit 202 of video encoder 200) may not signal the LIC flag.

Filtering deployed in the prediction domain may operate over a prediction block produced by different prediction tools, e.g. inter predicted samples can be sub-pel samples produced by interpolation of the reference picture samples, or predicted samples produced with help of sub-PU partitioning, affine prediction (e.g., implemented through sub-PU partitioning), OBMC, or inter prediction, each of which may utilize different processes (e.g., filters) to generate predicted samples.

A video coder (e.g., video encoder 200 or video decoder 300 or in some examples, mode selection unit 202 of video encoder 200, prediction processing unit 304 of video decoder 300) may be configured to adapt filter parameters depending on prediction block information. For example, the video coder may be configured to adapt parameters of prediction domain filtering, e.g., UDDF, bilateral (e.g., Hadamard) transform domain filters, etc. based on one or more of the following:
1. Predicted block parameters:
   a. Block size parameters (e.g., block sizes ratio horizontal size/vertical size, number of predicted samples within a block (e.g., number=height×width)). Said differently, a video coder (e.g., video encoder 200 or video decoder 300 or in some examples, mode selection unit 202 of video encoder 200, prediction processing unit 304 of video decoder 300) may be configured to adapt filter parameters (e.g., determine a filter type) based on one or both of a height of a current block or weight of the current block.
   b. Block partitioning: availability of the internal sub-pu boundaries within a current PU.
   c. Prediction mode: utilized for generating (some of) the predicted samples, e.g., the mode used for sub-PU prediction.
   d. Coding mode parameters, e.g., coding modes or QP.
2. Motion information: e.g., motion vector resolution and sub-pel position pointed to by MV, prediction direction, POC between currently coded picture and predicted picture, norm of the motion vector or other parameters related to a length of the motion (e.g., displacement) vectors along either of the coordinates.
3. Parameters of the reference sample: e.g., QP of the reference samples, coding or prediction mode for the reference samples.
4. Position of the filtered sample within the currently predicted block, e.g., different filter parameters can be applied to filter samples.

A video coder (e.g., video encoder 200 or video decoder 300 or in some examples, mode selection unit 202 of video encoder 200, prediction processing unit 304 of video decoder 300) may be configured to adjust parameters of filtering. For example, the video coder may be configured to adjust one or more of the following parameters:
1. Strength of the filter, e.g., characteristics of the pulse response and spectrum response
2. Filter tap length, filter coefficients, filter implementation, e.g., scale and offset, or finite impulse response (FIR), or BIF-style implementation
3. Filter directionality, e.g., horizontal, vertical filtering or localized 2D filter (e.g. diamond shape, square shape, plus shape)
4. A sub-sampling pattern.
5. Weight table or weight derivation or scale and offsets functions as used in Bilateral filtering
6. Thresholding, scaling function utilized in Hadamard transform domain filtering
7. Filter implementation can include non-linear components, such as clipping against the adaptive threshold. A 1D filtering example is given below:
   output_sample(t)=convolution (input_sample(y)′, h(i))
where t is a term defining sample 1D position, which is currently undergoing filtering, y is a term defining 1D positions of the input_samples used to produce the output_sample, h is the pulse response of the filter and I is filter tap index. The following equation impose bi-polar clipping against threshold T on deviation of the input_sample(y) used for filtering from the sample value at the filtered position input_sample(t):
   Input_sample(y)′=input_sample(t)+clip3(input_sample(y)−input_sample(t), −T, T,).

Said differently, for example, a filter type may specify one or more of the following: a strength of the filter; a filter tap length of the filter; a filter directionality of the filter; a sub-sampling pattern of the filter; a weight table, a weight derivation, or scale and offsets functions for the filter; thresholding and/or scaling function utilized in a Hadamard transform domain filtering for the filter; or non-linear components.
8. When several filters are used, such as for an interpolation filter or with the diffusion filter, signaling changes can be done:
   a. By changing the binarization of the filters; and/or
   b. By using different sets of filters.

For example, when several filters are used, such as, for example, for an interpolation filter or with the diffusion filter, a video encoder (e.g., video encoder 200 or in some examples, mode selection unit 202 of video encoder 200) may be configured to signal changes:
c. By changing the binarization of the filters; and/or
d. By using different sets of filters.

A video coder (e.g., video encoder 200 or video decoder 300 or in some examples, mode selection unit 202 of video encoder 200, prediction processing unit 304 of video decoder 300) may be configured to use one or more of the following signaling mechanisms:
1. Filter type, a filter id, and/or other parameters can be signalled to a video decoder through a dedicated syntax element of the coded bitstream. For example, a video encoder (e.g., video encoder 200 or in some examples, mode selection unit 202 of video encoder 200) may be configured to signal a filter type, an identifier (“id”), and/or other parameters to video decoder 300 through a dedicated syntax element of the coded bitstream.
2. Implicit signaling of a filter type, an id, and/or filter parameters. Filter parameters can be implicitly derived at the decoder side from side information and available coding information, such as predicted block parameters, motion information, parameters of reference picture (samples), partitioning information, e.g., sub-PU boundary availability within block, and/or spatial position of the filtered sample within a currently predicted block. For example, a video decoder (e.g., video decoder 300 or in some examples, prediction processing unit 304 of video decoder 300) may be configured to implicitly derive a filter type, an id, and/or a filter parameter, such as, for example, but not limited to, predicted block parameters, motion information, parameters of reference picture (samples), partitioning information, e.g. sub-PU boundary availability within block, and/or spatial position of the filtered sample within a currently predicted block
3. In some examples, a video coder (e.g., video encoder 200 or video decoder 300 or in some examples, mode selection unit 202 of video encoder 200, prediction processing unit 304 of video decoder 300) may be configured to deploy conditional or guided signaling of filter parameters. The video coder may be configured to use the above dependencies to reduce entropy of the information associated with current filter. This can be implemented either through specifying filter index derivation processes or conditions for signaling. Alternatively, entropy context can be initialized or adapted as function of available information.

A video coder (e.g., video encoder 200 or video decoder 300 or in some examples, mode selection unit 202 of video encoder 200, prediction processing unit 304 of video decoder 300) may be configured to use neighbouring samples in the following ways, in any combination:
1. The video coder may be configured to check an availability of neighbouring blocks every 4 samples.
2. Availability can be defined as simply the existence of the block and video encoder 200 and/or video decoder 300 may be configured to check the existence of the block as followed for the upper border
   avail[i]=((compArea.x+i*MIN_PU_SIZE)>=0 && (compArea.y−MIN_PU_SIZE)>=0);
for every i in 0 . . . CU_WIDTH/MIN_PU_SIZE
   where compArea is the area on which to filter
   for left border the availability is done as follows
   avail[i]=((compArea.x−MIN_PU_SIZE)>=0 && (compArea.y+i*MIN_PU_SIZE)>=0);
for every i in 0 . . . CU HEIGHT/MIN_PU_SIZE
   and for upper left block
   avail=((compArea.x−MIN_PU_SIZE)>=0 && (compArea.y−MIN_PU_SIZE)>=0);

Availability can be defined by use of samples only when they come from inter-predicted blocks. In this case, a video coder (e.g., video encoder 200 and/or video decoder 300) may be configured to perform another check, if the previous one holds.
For the left border:
CU::isInter(*tempCS->getCU(Position(compArea.x−MIN_PU_SIZE, compArea.y+i*MIN_PU_SIZE), toChannelType(COMPONENT_Y)))
And for the upper border and upper left block a similar process can be applied.

A video coder (e.g., video encoder 200 or video decoder 300 or in some examples, mode selection unit 202 of video encoder 200, prediction processing unit 304 of video decoder 300) may be configured for block dependent signaling. For example, the video coder may be configured such that signaling of the filter parameters, e.g., referenced by filter index, depend on the parameters of the block sizes (e.g., block sizes ratio of horizontal size/vertical size, number of predicted samples within a block (e.g., number=height×width)). Said differently, for example, a video decoder (e.g., video decoder 300 or in some examples, prediction processing unit 304 of video decoder 300) may be configured to determine, based on a height of a current block and/or a width of the current block and based on a filter index value of a syntax element signaled in a bitstream for video data, a filter type. In some examples, a video encoder (e.g., video encoder 300) may be configured to determine, based on a height of a current block and/or a width of the current block and based on a filter type, a filter index value.

A video coder (e.g., video encoder 200 or video decoder 300 or in some examples, mode selection unit 202 of video encoder 200, prediction processing unit 304 of video decoder 300) may be configured to limit, for block sizes below some threshold, prediction domain filtering, to a single type. In this way, the video coder may reduce a signalled filter index to filter a flag (e.g., am enable flag, a disable flag, etc.).

A video coder (e.g., video encoder 200 or video decoder 300 or in some examples, mode selection unit 202 of video encoder 200, prediction processing unit 304 of video decoder 300) may be configured to determine a block size parameter as multiplication of height*width of a processed block. In some examples, the video coder may be configured to determine a block size parameter based on a minimal or maximal length of the block min (e.g., height, width). The video coder may be configured to determine a block size parameter based on a max height and/or width. The video coder may be configured to determine a block size parameter based on a diagonal of a block.

A video coder (e.g., video encoder 200 or video decoder 300 or in some examples, mode selection unit 202 of video encoder 200, prediction processing unit 304 of video decoder 300) may be configured to compare parameters of the block against a threshold T. A video encoder (e.g., video encoder 200 or in some examples, mode selection unit 202 of video encoder 200) may signal threshold T through a coded bitstream or by providing the threshold T as a side information, e.g., by providing a threshold as integer value, e.g. T=4, . . . , 128 or other. Below is an example.
numberFilters=(height*width<T) ? 1: N, where N is the number of filters that can be utilized for filtering block.

A video coder (e.g., video encoder 200 or video decoder 300 or in some examples, mode selection unit 202 of video encoder 200, prediction processing unit 304 of video decoder 300) may be configured to use different signalling methods depending on the numberFilters value. In some examples, different contexts for adaptive context entropy codec can be utilized for signaling a filter index.
if (numberFilters==1)
   ctx=context1;
else
   ctx=context2;

The following element may be decoded using the context (ctx) with context-adaptive arithmetic entropy-coded syntax.

| | |
|---|---|
| cu_diff_filter_idx | ae(v) |

Alternatively, in some examples:

if (numFilters == 1)
{

| | |
|---|---|
| cu_diff_filter_idx | u(1) |

}
else
{

| | |
|---|---|
| cu_diff_filter_idx | ae(v) |

}

Thus, the following signaling can be employed for numFilters>1

Where cu_diff_filter_idx=0 defines no filter application and values cu_diff_filter_idx=1 . . . 3 specify 3 different filters:

| cu_diff_filter_idx | Bin string |
|---|---|
| 0 | 0 |
| 1 | 10 |
| 2 | 110 |
| 2 | 111 |

The following signaling can be employed for numFilters==1

| cu_diff_filter_idx | Bin string |
|---|---|
| 0 | 0 |
| 1 | 1 |

where cu_diff_filter_idx=0 defines no filter application and value cu_diff_filter_idx=1 defines a filter applied to the processed block.

In some examples, a video coder (e.g., video encoder 200 and/or video decoder 300) may be configured to use a ratio between width and heights to adapt an interpretation process for decoded syntax element. Said differently, for example, a video decoder (e.g., video decoder 300 or in some examples, prediction processing unit 304 of video decoder 300) may be configured to determine a block size parameter based on a ratio of the height of the current block and the width of the current block and determine a filter type from a filter index value based on the block size parameter. In some examples, a video encoder (e.g., video encoder 200 or in some examples, mode selection unit 202 of video encoder 200) may be configured to determine a block size parameter based on a ratio of the height of the current block and the width of the current block and determine a filter index value to indicate a filter type based on the block size parameter. A non-limiting example is shown below.

For an integer values N (e.g. value of power of 2), a video coder (e.g., video encoder 200 or video decoder 300 or in some examples, mode selection unit 202 of video encoder 200, prediction processing unit 304 of video decoder 300) may be configured to define a set of filters as follows:

filterType0=1 is a filter suitable for local 2D filtering, e.g., 3×3 tap length filtering, or 3×3 tap length filtering in a form of a plus or diamond shape.

filterType1=2 is a filter suitable for directional filtering, e.g., a long 1D tap length filter aligned in one of the directions, e.g., in the horizontal direction.

filterType2=3 is a filter suitable for directional filtering, e.g., a long 1D tap length filter aligned in another direction, e.g., in a vertical direction.

if (width>N*height)
cu_diff_filter_idx=filterType1;
   else if (height>N*width)
cu_diff_filter_idx=filterType2;
   else
cu_diff_filter_idx=filterType0,

Thus, the following signaling mechanism or syntax element interpretation table at the decoder side can be defined as a default interpretation table, an example of which is shown in Table 4.

TABLE 4
Example default interpretation table.

| FilterIdx | cu_diff_filter_idx | Bin string |
|---|---|---|
| No Filter | 0 | 0 |
| filterType1 | 1 | 10 |
| filterType2 | 2 | 110 |
| filterType3 | 3 | 111 |

In some examples, for predicted blocks with width and height ratios such that (width>N*height), the signalling/interpretation mechanism can be changed as indicated in Table 5.

TABLE 5
Example table for width > N * height.

| Filterldx | cu_diff_filter_idx | Bin string |
|---|---|---|
| No Filter | 0 | 0 |
| filterType2 | 1 | 10 |
| filterTypel | 2 | 110 |
| filterType3 | 3 | 111 |

where filterType2 is an index defining a filter more suitable for a block larger in the horizontal direction than in a vertical direction, e.g., horizontal filtering.

That is, for example, a video decoder (e.g., video decoder 300 or in some examples, prediction processing unit 304 of video decoder 300) may be configured to select a first filter type (e.g., “filterType1”) when the syntax element indicates the filter index value corresponds to a first value (e.g., cu_diff_filter_idx=1) and when the width of the current block is equal to or less than a result of multiplying the height of the current block and a threshold (e.g., width≤N*height). In this example, the video decoder may be configured to select a second filter type (e.g., “filterType2”) when the syntax element indicates the filter index value corresponds to the first value (e.g., cu_diff_filter_idx=1) and when the width of the current block is greater than the result of multiplying the height of the current block and the threshold (e.g., width>N*height). In this example, the video decoder may be configured to select the second filter type (e.g., “filterType2”) when the syntax element indicates the filter index value corresponds to a second value (e.g., cu_diff_filter_idx=2) different from the first value and when the width of the current block is equal to or less than the result of multiplying the height of the current block and the threshold (e.g., width≤N*height).

Similarly, for example, a video encoder (e.g., video encoder 200 or in some examples, mode selection unit 202 of video encoder 200) may be configured to select a filter index value corresponding to a first value (e.g., cu_diff_filter_idx=1) when the filter is a first filter type (e.g., “filter Type1”) and when the width of the current block is equal to or less than a result of multiplying the height of the current block and a threshold (e.g., width≤N*height). In this example, the video encoder may be configured to select filter index value corresponding to a second value (e.g., cu_diff_filter_idx=2) when the filter is a first filter type (e.g., “filter Type1”) and when the width of the current block is greater than a result of multiplying the height of the current block and a threshold (e.g., width>N*height).

In some examples, for predicted blocks with width and height ratios such that (height>N*width), the signalling/interpretation mechanism can changed as indicated in Table 6.

TABLE 6
Example table for height > N * width.

| FilterIdx | cu_diff_filter_idx | Bin string |
|---|---|---|
| No Filter | 0 | 0 |
| filterType3 | 1 | 10 |
| filterType1 | 2 | 110 |
| filterType2 | 3 | 111 |

where filterType3 is an index defining a filter more suitable for blocks larger in the vertical direction than in the horizontal direction, e.g., vertical filtering.

That is, for example, a video decoder (e.g., video decoder 300 or in some examples, prediction processing unit 304 of video decoder 300) may be configured to select a first filter type (e.g., “filterType1”) when the syntax element indicates the filter index value corresponds to a first value (e.g., cu_diff_filter_idx=1) and when a height of a current block is equal to or less than a result of multiplying a width of the current block and a threshold (e.g., height≤N*width). In this example, the video decoder may be configured to select a second filter type (e.g., “filterType3”) when the syntax element indicates the filter index value corresponds to the first value (e.g., cu_diff_filter_idx=1) and when a height of a current block is greater than a result of multiplying a width of the current block and a threshold (e.g., height>N*width). In this example, the video decoder may be configured to select the second filter type (e.g., “filterType3”) when the syntax element indicates the filter index value corresponds to a second value (e.g., cu_diff_filter_idx=3) different from the first value and when a height of a current block is equal to or less than a result of multiplying a width of the current block and a threshold (e.g., height≤N*width).

Similarly, for example, a video encoder (e.g., video encoder 200 or in some examples, mode selection unit 202 of video encoder 200) may be configured to select a filter index value corresponding to a first value (e.g., cu_diff_filter_idx=1) when the filter is a first filter type (e.g., “filter Type1”) and when a height of a current block is equal to or less than a result of multiplying a width of the current block and a threshold (e.g., height≤N*width). In this example, the video encoder may be configured to select filter index value corresponding to a second value (e.g., cu_diff_filter_idx=2) when the filter is a first filter type (e.g., “filter Type1”) and when a height of a current block is greater than a result of multiplying a width of the current block and a threshold (e.g., height>N*width).

In some examples, for predicted blocks with block sizes of certain size (e.g. width*height>M, where M is an integer number) the signalling/interpretation mechanism can changed as shown in Table 7. Said differently, for example, a video decoder (e.g., video decoder 300 or in some examples, prediction processing unit 304 of video decoder 300) may be configured to determine a block size parameter based on a multiplication of a height of a current block and/or a width of the current block and determine a filter type from a filter index value based on the block size parameter. In some examples, a video encoder (e.g., video encoder 200 or in some examples, mode selection unit 202 of video encoder 200) may be configured to determine a block size parameter based on a multiplication of a height of a current block and/or a width of the current block and determine a filter index value to indicate a filter type based on the block size parameter. The signalling/interpretation mechanism can change as indicated in Table 7.

TABLE 7
Example table for width* height > M.

| FilterIdx | cu_diff_filter_idx | Bin string |
|---|---|---|
| No Filter | 0 | 0 |
| filterType2 | 1 | 10 |
| filterType3 | 2 | 110 |
| filterType1 | 3 | 111 |

where filterType1 is an index defining a filter more suitable for small block sizes.

That is, for example, a video decoder (e.g., video decoder 300 or in some examples, prediction processing unit 304 of video decoder 300) may be configured to select a first filter type (e.g., “filterType1”) when the syntax element indicates the filter index value corresponds to a first value (e.g., cu_diff_filter_idx=1) and when a result of multiplying the height of the current block and the width of the current block is equal to or less than a threshold (e.g., width*height≤M). In this example, the video decoder may be configured to select a second filter type (e.g., “filterType2”) when the syntax element indicates the filter index value corresponds to the first value (e.g., cu_diff_filter_idx=1) and when a result of multiplying the height of the current block and the width of the current block is greater than the threshold (e.g., width*height>M). In this example, the video decoder may be configured to select the second filter type (e.g., “filterType2”) when the syntax element indicates the filter index value corresponds to a second value (e.g., cu_diff_filter_idx=2) different from the first value and when a result of multiplying the height of the current block and the width of the current block is equal to or less than a threshold (e.g., width*height≤M).

Similarly, for example, a video encoder (e.g., video encoder 200 or in some examples, mode selection unit 202 of video encoder 200) may be configured to select a filter index value corresponding to a first value (e.g., cu_diff_filter_idx=1) when the filter is a first filter type (e.g., “filter Type1”) and when a result of multiplying the height of the current block and the width of the current block is equal to or less than a threshold (e.g., width*height≤M). In this example, the video encoder may be configured to select a filter index value corresponding to a second value (e.g., cu_diff_filter_idx=3) when the filter is a first filter type (e.g., “filter Type1”) and when a result of multiplying the height of the current block and the width of the current block is greater than the threshold (e.g., width*height>M).

A video coder (e.g., video encoder 200 or video decoder 300 or in some examples, mode selection unit 202 of video encoder 200, prediction processing unit 304 of video decoder 300) may be configured to determine motion vector parameters based on a signaling mechanism. For example, the video coder may be configured to signal filter parameters (e.g., referenced by a filter index) based on the motion vector parameters, such as, for example, but not limited to, a norm or a MV length, a MV direction or a magnitude of the MV components along either direction. In some examples, the video coder may be configured to determine signaled filter parameters (e.g., referenced by a filter index) based on the motion vector parameters, such as, for example, but not limited to, a norm or a MV length, a MV direction or a magnitude of the MV components along either direction.

A video coder (e.g., video encoder 200 or video decoder 300 or in some examples, mode selection unit 202 of video encoder 200, prediction processing unit 304 of video decoder 300) may be configured to apply a specified filter index derivation logic based on a function of motion vector norm (e.g. abs(mv.hor)+abs(mv.ver)>T), where T is an integer value 0 . . . M, where a video encoder (e.g., video encoder 200) may be configured to signal filter parameters (e.g., referenced by a filter index) based on the motion vector parameters, such as, for example, but not limited to, a norm or a MV length, a MV direction or a magnitude of the MV components along either direction, where mv.hor is a horizontal component of the motion vector, where mv.ver is a vertical component of the motion vector, and where M is the maximal allowed magnitude of the motion vector component. A video encoder (e.g., video encoder 200 or in some examples, mode selection unit 202 of video encoder 200) may be configured to provide the maximum allowed magnitude of the motion vector component “M” to video decoder 300 as side information. In some examples, the video coder may derive the maximum allowed magnitude of the motion vector component “M” from parameters of currently coded picture size (e.g., resolution). In some examples, a video encoder (e.g., video encoder 200 or in some examples, mode selection unit 202 of video encoder 200) may be configured to provide the value T to a video decoder (e.g., video decoder 300 or in some examples, prediction processing unit 304 of video decoder 300) by, for example, syntax elements through a coded bitstream at sequence, PPS and/or tiles group header level.

A video coder (e.g., video encoder 200 or video decoder 300 or in some examples, mode selection unit 202 of video encoder 200, prediction processing unit 304 of video decoder 300) may be configured to apply filter index derivation logic that can utilize different sub-sets of filter indexes among an available filter set.

A video coder (e.g., video encoder 200 or video decoder 300 or in some examples, mode selection unit 202 of video encoder 200, prediction processing unit 304 of video decoder 300) may be configured to apply a signaling/interpretation mechanism as follows.

In this example, a filter set is S0={filterType1, filterType2, filterType3}

If(abs(mv.hor)+abs(mv.ver)>T)
filters=S1
with S1={filterType1, FilterType2}

else
filters=S2
with S2={filterType3, FilterType2}
   where filterType1 is more suitable for blocks predicted through a motion vector of small norm and filterType3 is more suitable for blocks predicted through a vector with a motion vector of large norm.

For example, a video coder (e.g., video encoder 200 or video decoder 300 or in some examples, mode selection unit 202 of video encoder 200, prediction processing unit 304 of video decoder 300) may be configured to select a first sub-set of filter indexes from an available filter set based on motion vector norm. More specifically, for example, the video coder may be configured to select a first sub-set of filter indexes from an available filter set based on abs(mv.hor)+abs(mv.ver)>T. For instance, the video coder may be configured to select a first sub-set of filter indexes (e.g., that includes FilterType1 and FilterType 2) when the motion vector norm is greater than a threshold T and to select a second sub-set of filter indexes (e.g., that includes FilterType3 and FilterType 2) when the motion vector norm is not greater than (e.g., equal to or less than) a threshold T.

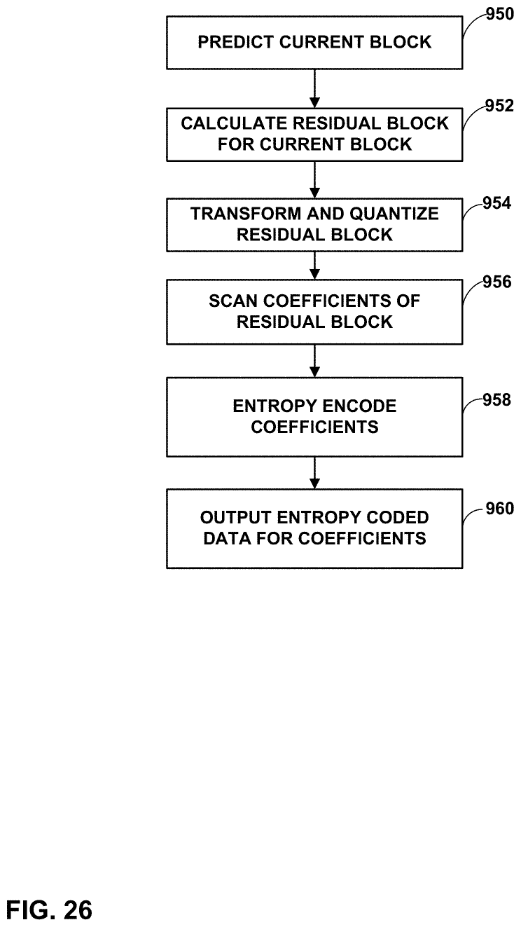

FIG. 26 is a flowchart illustrating an example method for encoding a current block. The current block may include a current CU. Although described with respect to video encoder 200 (FIGS. 1 and 3), other devices may be configured to perform a method similar to that of FIG. 26.

In this example, a mode selection unit 202 predicts the current block (950). For example, mode selection unit 202 may filter prediction information using a filter type to generate filtered prediction information. In this example, mode selection unit 202 may form a prediction block for the current block based on the filtered prediction information. Motion compensation unit 224 may filter prediction information using a filter type to generate filtered prediction information. Residual generation unit 204 may calculate a residual block for the current block (952). To calculate the residual block, residual generation unit 204 may calculate a difference between the original, uncoded block and the prediction block for the current block. Transform processing unit 206 with quantization unit 208 may transform and quantize coefficients of the residual block (954). Entropy encoding unit 220 may scan the quantized transform coefficients of the residual block (956). During the scan, or following the scan, entropy encoding unit 220 may entropy encode the coefficients (958). For example, entropy encoding unit 220 may encode the coefficients using CAVLC or CABAC. Mode selection unit 202 may determine, based on one or both of a height of the current block or a width of the current block, a filter type indicated by the filter index value. Entropy encoding unit 220 may entropy encode a syntax element indicating the filter index value in, for example, a bitstream for the video data. Entropy encoding unit 220 may then output the entropy coded data of the block (960).

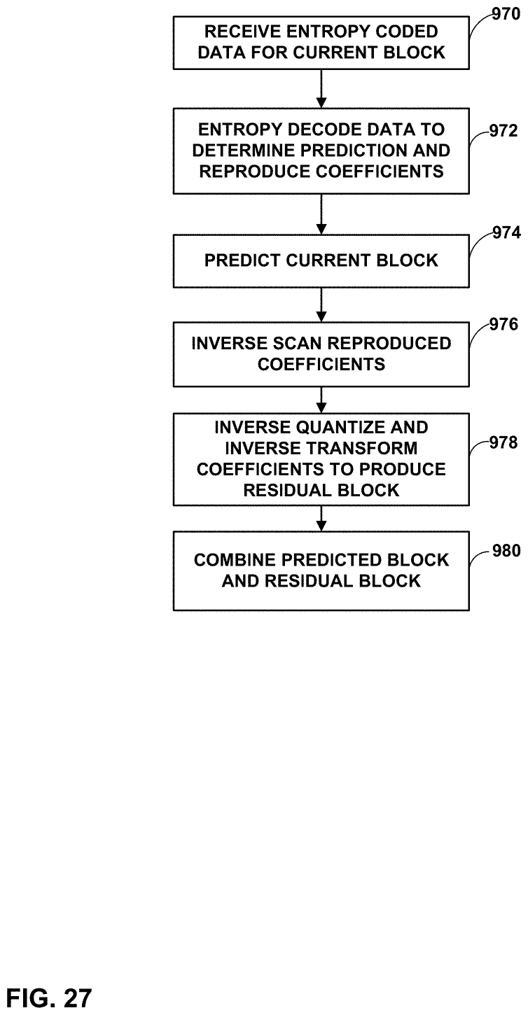

FIG. 27 is a flowchart illustrating an example method for decoding a current block of video data. The current block may include a current CU. Although described with respect to video decoder 300 (FIGS. 1 and 4), other devices may be configured to perform a method similar to that of FIG. 27.

Entropy decoding unit 302 may receive entropy coded data for the current block, such as entropy coded prediction information and entropy coded data for coefficients of a residual block corresponding to the current block (970). Entropy decoding unit 302 may entropy decode the entropy coded data to determine prediction information for the current block and to reproduce coefficients of the residual block (972). Entropy decoding unit 302 may entropy decode a filter index value indicated by a syntax element signaled in a bitstream for the video data. Prediction processing unit 304 may determine, based on one or both of a height of the current block or a width of the current block, a filter type indicated by the filter index value. Prediction processing unit 304 may predict the current block (974), e.g., using an intra- or inter-prediction mode as indicated by the prediction information for the current block, to calculate a prediction block for the current block. For example, prediction processing unit 304 may filter the prediction information using the filter type to generate filtered prediction information.

Entropy decoding unit 302 may inverse scan the reproduced coefficients (976), to create a block of quantized transform coefficients. Inverse quantization unit 306 with inverse transform processing unit 308 may inverse quantize and inverse transform the coefficients to produce a residual block (978). Reconstruction unit 310 may ultimately decode the current block by combining the prediction block and the residual block (980). As shown, filter unit 312 may filter the output of reconstruction unit 310.

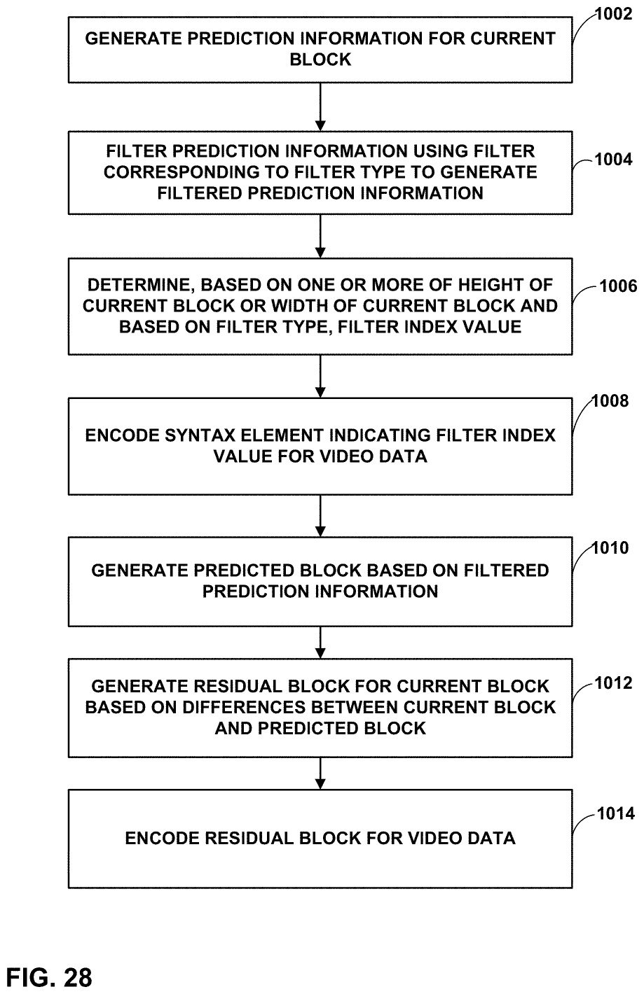

FIG. 28 is a flowchart illustrating an example method for encoding a current block using block dependent signaling. Although described with respect to video encoder 200 (FIGS. 1 and 3), other devices may be configured to perform a method similar to that of FIG. 28.

Mode selection unit 202 may generate prediction information for a current block (1002). Motion compensation unit 224 may filter the prediction information using a filter corresponding to a filter type to generate filtered prediction information (1004). Mode selection unit 202 may determine, based on one or more of a height of the current block or a width of the current block and based on the filter type, a filter index value (1006). For example, mode selection unit 202 cause entropy encoding unit 220 to signal a filter index value of a particular value (e.g., ‘1’) representing a first filter type when a current block has a first block size (e.g., block sizes having more than 64 samples). In this example, mode selection unit 202 may cause entropy encoding unit 220 to signal the filter index value of the particular value (e.g., ‘1’) representing a second filter type when the current block has a second block size (e.g., block sizes having less than 64 samples). In this way, mode selection unit 202 may binarize the filter type differently depending on a block size parameter (e.g., ratio of height to width, block size, etc.). Configuring mode selection unit 202 for block dependent signaling may reduce an amount of information signaled in a bitstream compared to video encoders and video decoders that do not use block dependent signaling.

Entropy encoding unit 220 may encode (e.g., entropy encode) a syntax element indicating the filter index value for the video data (1008). Mode selection unit 202 may generate a predicted block based on the filtered prediction information (1010). Residual generation unit 204 may generate a residual block for the current block based on differences between the current block and the one or more prediction block (1012). Entropy encoding unit 220 may encode the residual block in the bitstream for the video data (1014).

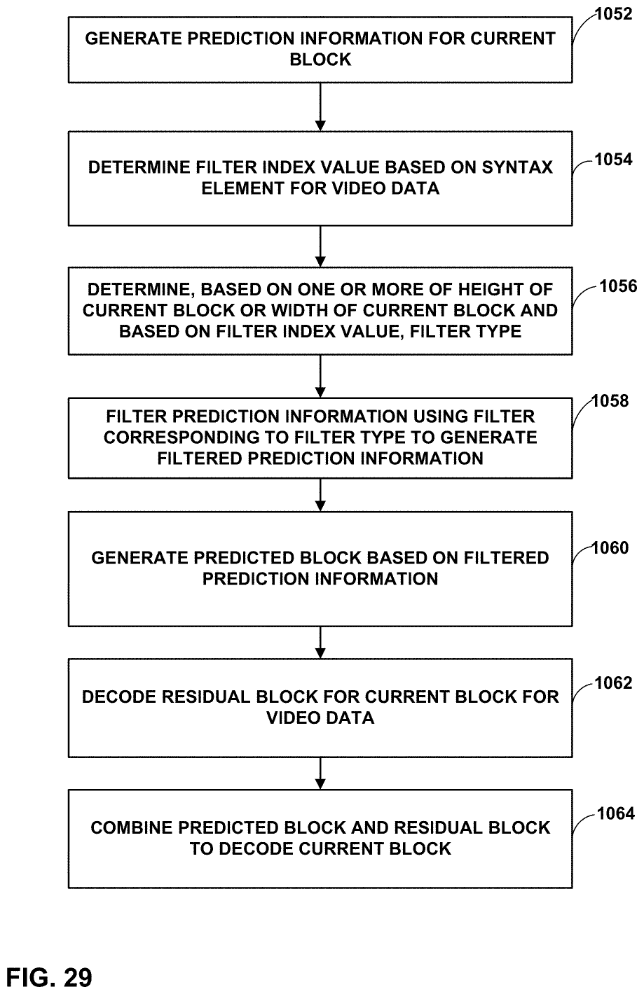

FIG. 29 is a flowchart illustrating an example method for decoding a current block of video data using block dependent signaling. Although described with respect to video decoder 300 (FIGS. 1 and 4), other devices may be configured to perform a method similar to that of FIG. 29.

Prediction processing unit 304 may generate prediction information for a current block (1052). Entropy decoding unit 302 may determine a filter index value based on a syntax element for the video data (1054). Prediction processing unit 304 may determine, based on one or more of a height of the current block or a width of the current block and based on filter index value, a filter type (1056). For example, prediction processing unit 304 may interpret a filter index value of a particular value (e.g., ‘1’) as representing a first filter type when a current block has a first block size (e.g., block sizes having more than 64 samples). In this example, prediction processing unit 304 may interpret the filter index value of the particular value (e.g., ‘1’) as representing a second filter type when the current block has second block size (e.g., block sizes having less than 64 samples). In this way, prediction processing unit 304 may support inverse binarizing the filter type differently depending on a block size parameter (e.g., ratio of height to width, block size, etc.). Configuring prediction processing unit 304 for block dependent signaling may reduce an amount of information signaled in a bitstream compared to video decoders that do not use block dependent signaling.

Motion compensation unit 316 may filter the prediction information using a filter corresponding to the filter type to generate filtered prediction information (1058). Prediction processing unit 304 may generate a predicted block based on the filtered prediction information (1060). Entropy decoding unit 302 may decode a residual block for the current block from the bitstream for the video data (1062). Reconstruction unit 310 may combine the predicted block and the residual block to decode the current block (1064).

Illustrative examples of the disclosure include:

### Example 1

A method of processing video data, the method comprising: generating, by a video coder, prediction information for a current block; adapting, by the video coder, filter parameters of a filter depending on prediction block information; and filtering, by the video coder, the prediction information using the adapted filter parameters.

### Example 2

The method of example 1, wherein the predicted block information comprises one or more of predicted block parameters, motion information, parameters of a reference sample, or a position of a filtered sample within a currently predicted block.

### Example 3

The method of any combination of examples 1-2, wherein the predicted block parameters comprises one or more of block size parameters, block partitioning information, a prediction mode, or coding mode parameters.

### Example 4

The method of any combination of examples 1-3, wherein adapting comprises adapting one or more of the following: a strength of the filter; a filter tap length of the filter; a filter directionality of the filter; a sub-sampling pattern of the filter; a weight table, a weight derivation, or scale and offsets functions for the filter; thresholding and/or scaling function utilized in a Hadamard transform domain filtering for the filter; or non-linear components.

### Example 5

The method of any combination of examples 1-4, wherein the video coder is a video encoder, the method further comprising: signaling, by the video encoder, a filter type, id, and parameters to a video decoder.

### Example 6

The method of any combination of examples 1-4, wherein the video coder is a video decoder, the method further comprising: determining, by the video decoder, a filter type, id, and parameters to a video decoder from side information and available coding information.

### Example 7

The method of any combination of examples 1-6, wherein the video coder uses neighbouring samples.

### Example 8

The method of any combination of examples 1-4 and 7, wherein the video coder is a video encoder, the method further comprising: determining, by the video encoder, to signal based on parameters of block sizes; and signaling, by the video encoder, filter parameters to a video decoder in response to determining to signal.

### Example 9

The method of any combination of examples 1-5 and 7, wherein the video coder is a video encoder, the method comprising signaling filter parameters, wherein signaling filter parameters comprises: changing the binarization of the filters; and/or using different sets of filters.

### Example 10

The method of any combination of examples 1-5,7, and 8 wherein the video coder is a video encoder, the method comprising: signaling filter parameters based on the motion vector parameters.

### Example 11

The method of any combination of examples 1-4,6, and 7, wherein the video coder is a video decoder, the method comprising: determining signaled filter parameters based on the motion vector parameters.

### Example 12

The method of example 11, wherein determining the signaled filter parameters comprises: applying a specified filter index derivation logic that is based on a function of motion vector norm.

### Example 13

The method of example 12, wherein applying the specified filter index derivation logic comprises calculating abs(mv.hor)+abs(mv.ver)>T), wherein T is an integer value 0 . . . M, wherein mv.hor is a horizontal component of the motion vector, wherein mv.ver is a vertical component of the motion vector, and wherein M is the maximal allowed magnitude of the motion vector component.

### Example 14

The method of example 13, wherein the video decoder receives M from a video encoder.

### Example 15

The method of example 13, wherein the video decoder derives M based on parameters of a currently coded picture size.

### Example 16

The method of example 13, wherein the video decoder receives T from a video encoder.

### Example 17

The method of any combination of example 1-16, further comprising: selecting a sub-set of filter indexes from an available filter set based on a motion vector norm.

### Example 18

The method of example 17, wherein selecting the sub-set of filter indexes comprises: calculating abs(mv.hor)+abs(mv.ver)>T, wherein T is an integer value 0 . . . M, wherein mv.hor is a horizontal component of the motion vector, wherein mv.ver is a vertical component of the motion vector, and wherein M is the maximal allowed magnitude of the motion vector component.

### Example 19

A device for coding video data, the device comprising one or more means for performing the method of any of examples 1-18.

### Example 20

The device of example 19, wherein the one or more means comprise one or more processors implemented in circuitry.

### Example 21

The device of any of examples 19 and 20, further comprising a memory to store the video data.

### Example 22

The device of any of examples 19-21, further comprising a display configured to display decoded video data.

### Example 23

The device of any of examples 19-22, wherein the device comprises one or more of a camera, a computer, a mobile device, a broadcast receiver device, or a set-top box.

### Example 24

The device of any of examples 19-23, wherein the device comprises a video decoder.

### Example 25

The device of any of examples 19-24, wherein the device comprises a video encoder.

### Example 26

A computer-readable storage medium having stored thereon instructions that, when executed, cause one or more processors to perform the method of any of examples 1-18.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
generating, by a video decoder implemented in circuitry, prediction information for a current block;
determining, by the video decoder, a filter index value based on a syntax element signaled for the video data;
determining, by the video decoder, based on one or more of a height of the current block or a width of the current block and based on the filter index value, a filter type; and
filtering, by the video decoder, the prediction information using a filter corresponding to the filter type to generate filtered prediction information.

2. The method of claim 1, comprising:
determining, by the video decoder, a block size parameter based on a multiplication of the height of the current block and the width of the current block, wherein determining the filter type comprises determining the filter type based on the block size parameter.

3. The method of claim 1, comprising:
determining, by the video decoder, a block size parameter based on a ratio of the height of the current block and the width of the current block, wherein determining the filter type comprises determining the filter type based on the block size parameter.

4. The method of claim 1, wherein determining the filter type comprises:
selecting a first filter type when the syntax element indicates the filter index value corresponds to a first value and when the width of the current block is equal to or less than a result of multiplying the height of the current block and a threshold; and
selecting a second filter type when the syntax element indicates the filter index value corresponds to the first value and when the width of the current block is greater than the result of multiplying the height of the current block and the threshold.

5. The method of claim 4, wherein determining the filter type comprises:
selecting the second filter type when the syntax element indicates the filter index value corresponds to a second value different from the first value and when the width of the current block is equal to or less than the result of multiplying the height of the current block and the threshold.

6. The method of claim 1, wherein determining the filter type comprises:
selecting a first filter type when the syntax element indicates the filter index value corresponds to a first value and when the height of the current block is equal to or less than a result of multiplying the width of the current block and a threshold; and
selecting a second filter type when the syntax element indicates the filter index value corresponds to the first value and when the height of the current block is greater than the result of multiplying the width of the current block and the threshold.

7. The method of claim 6, wherein determining the filter type comprises:
selecting the second filter type when the syntax element indicates the filter index value corresponds to a second value different from the first value and when the height of the current block is equal to or less than the result of multiplying the width of the current block and the threshold.

8. The method of claim 1, wherein determining the filter type comprises:
selecting a first filter type when the syntax element indicates the filter index value corresponds to a first value and when a result of multiplying the height of the current block and the width of the current block is equal to or less than a threshold; and
selecting a second filter type when the syntax element indicates the filter index value corresponds to the first value and when the result of multiplying the height of the current block and the width of the current block is greater than the threshold.

9. The method of claim 8, wherein determining the filter type comprises:
selecting the second filter type when the syntax element indicates the filter index value corresponds to a second value different from the first value and when the result of multiplying the height of the current block and the width of the current block is equal to or less than the threshold.

10. The method of claim 1, wherein the filter type specifies one or more of the following:
a strength of the filter;
a filter tap length of the filter;
a filter directionality of the filter;
a sub-sampling pattern of the filter;
a weight table, a weight derivation, or scale and offsets functions for the filter;
one or both of a thresholding or scaling function utilized in a Hadamard transform domain filtering for the filter; or
non-linear components.

11. The method of claim 1, comprising:
generating, by the video decoder, a predicted block based on the filtered prediction information;
decoding, by the video decoder, a residual block for the current block from a bitstream for the video data; and
combining, by the video decoder, the predicted block and the residual block to decode the current block.

12. A method of encoding video data, the method comprising:
generating, by a video encoder implemented in circuitry, prediction information for a current block;
filtering, by the video encoder, the prediction information using a filter corresponding to a filter type to generate filtered prediction information;
determining, by the video encoder, based on one or more of a height of the current block or a width of the current block and based on the filter type, a filter index value; and
encoding, by the video encoder, a syntax element based on the filter index value.

13. The method of claim 12, comprising:
determining, by the video encoder, a block size parameter based on a multiplication of the height of the current block and the width of the current block, wherein determining the filter index value comprises determining the filter index value based on the block size parameter.

14. The method of claim 12, comprising:
determining, by the video encoder, a block size parameter based on a ratio of the height of the current block and the width of the current block, wherein determining the filter index value comprises determining the filter index value based on the block size parameter.

15. The method of claim 12, comprising:
generating, by the video encoder, a predicted block based on the filtered prediction information;
generating, by the video encoder, a residual block for the current block based on differences between the current block and the predicted block; and
encoding, by the video encoder, the residual block in the bitstream for the video data.

16. A device for decoding video data, the device comprising:
a memory configured to store video data; and
one or more processors implemented in circuitry and configured to:
generate prediction information for a current block;
determine a filter index value based on a syntax element signaled for the video data;
determine, based on one or more of a height of the current block or a width of the current block and based on the filter index value, a filter type; and
filter the prediction information using a filter corresponding to the filter type to generate filtered prediction information.

17. The device of claim 16, wherein the one or more processors are configured to determine a block size parameter based on a multiplication of the height of the current block and the width of the current block, wherein, to determine the filter type, the one or more processors are configured to determine the filter type based on the block size parameter.

18. The device of claim 16, wherein the one or more processors are configured to determine a block size parameter based on a ratio of the height of the current block and the width of the current block, wherein, to determine the filter type, the one or more processors are configured to determine the filter type based on the block size parameter.

19. The device of claim 16, wherein, to determine the filter type, the one or more processors are configured to:
select a first filter type when the syntax element indicates the filter index value corresponds to a first value and when the width of the current block is equal to or less than a result of multiplying the height of the current block and a threshold; and
select a second filter type when the syntax element indicates the filter index value corresponds to the first value and when the width of the current block is greater than the result of multiplying the height of the current block and the threshold.

20. The device of claim 16, wherein, to determine the filter type, the one or more processors are configured to select the second filter type when the syntax element indicates the filter index value corresponds to a second value different from the first value and when the width of the current block is equal to or less than the result of multiplying the height of the current block and the threshold.

21. The device of claim 16, wherein, to determine the filter type, the one or more processors are configured to:
select a first filter type when the syntax element indicates the filter index value corresponds to a first value and when the height of the current block is equal to or less than a result of multiplying the width of the current block and a threshold; and
select a second filter type when the syntax element indicates the filter index value corresponds to the first value and when the height of the current block is greater than the result of multiplying the width of the current block and the threshold.

22. The device of claim 21, wherein, to determine the filter type, the one or more processors are configured to select the second filter type when the syntax element indicates the filter index value corresponds to a second value different from the first value and when the height of the current block is equal to or less than the result of multiplying the width of the current block and the threshold.

23. The device of claim 16, wherein, to determine the filter type, the one or more processors are configured to:
select a first filter type when the syntax element indicates the filter index value corresponds to a first value and when a result of multiplying the height of the current block and the width of the current block is equal to or less than a threshold; and
select a second filter type when the syntax element indicates the filter index value corresponds to the first value and when the result of multiplying the height of the current block and the width of the current block is greater than the threshold.

24. The device of claim 23, wherein, to determine the filter type, the one or more processors are configured to select the second filter type when the syntax element indicates the filter index value corresponds to a second value different from the first value and when the result of multiplying the height of the current block and the width of the current block is equal to or less than the threshold.

25. The device of claim 16, wherein the filter type specifies one or more of the following:
a strength of the filter;
a filter tap length of the filter;
a filter directionality of the filter;
a sub-sampling pattern of the filter;
a weight table, a weight derivation, or scale and offsets functions for the filter;
one or both of a thresholding or scaling function utilized in a Hadamard transform domain filtering for the filter; or
non-linear components.

26. The device of claim 16, wherein the one or more processors are configured to:
generate a predicted block based on the filtered prediction information;
decode a residual block for the current block from a bitstream for the video data; and
combine the predicted block and the residual block to decode the current block.

27. The device of claim 16, wherein the device comprises one or more of a camera, a computer, a mobile device, a broadcast receiver device, or a set-top box.

28. A device for encoding video data, the device comprising:
a memory configured to store video data; and
one or more processors implemented in circuitry and configured to:
generate prediction information for a current block;
filter the prediction information using a filter corresponding to a filter type to generate filtered prediction information;
determine, based on one or more of a height of the current block or a width of the current block and based on the filter type, a filter index value; and
encode a syntax element based on the filter index value.

29. The device of claim 28, wherein the one or more processors are configured to determine a block size parameter based on a multiplication of the height of the current block and the width of the current block, wherein, to determine the filter index value, the one or more processors are configured to determine the filter index value based on the block size parameter.

30. The device of claim 28, wherein the one or more processors are configured to determine a block size parameter based on a ratio of the height of the current block and the width of the current block, wherein, to determine the filter index value, the one or more processors are configured to determine the filter index value based on the block size parameter.
